(19) United States
(12) Patent Application Publication
(10) Pub. No.: US 2017/0068952 A1
(43) Pub. Date: Mar. 9, 2017

(54) SYSTEM FOR ELECTRONIC COLLECTION AND DISPLAY OF ACCOUNT TOKEN USAGE AND ASSOCIATION

(71) Applicant: BANK OF AMERICA CORPORATION, Charlotte, NC (US)

(72) Inventors: Tammy L. Brockmann, Fort Mill, SC (US); Lauren Marie Zavodny, Charlotte, NC (US); Stephen Philip Selfridge, Huntersville, NC (US); Gregory Joseph Lloyd, Charlotte, NC (US)

(21) Appl. No.: 14/871,759

(22) Filed: Sep. 30, 2015

Related U.S. Application Data
(60) Provisional application No. 62/213,963, filed on Sep. 3, 2015.

(51) Int. Cl. G06Q 20/36; G06Q 20/40

(52) U.S. Cl. CPC G06Q 20/363; G06Q 20/405

(57) ABSTRACT

Embodiments of the invention are directed to electronic collection, display and association of payment credentials or tokens by providing a comprehensive management platform for managing multiple digital wallets. The invention provides an integrated digital wallet management interface that enables the user to view and modify the payment credentials or tokens associated with the multiple wallets, stored at different locations, without requiring the user to access the payment credentials or tokens thorough conventional channels separately. In this regard, the integrated digital wallet management interface may display one or more payment credentials on a dashboard on a user mobile device along with one or more characteristics of the payment credentials. Embodiments of the invention are also directed to authenticate the user and enable the user to initiate one or more transactions associated with the payment credentials or tokens from a single interface.

### CROSS-REFERENCE TO PRIORITY APPLICATION

This application claims the benefit of U.S. Patent Application Ser. No. 62/213,963 entitled a System for Electronic Collection and Display of Account Token Usage and Association (filed Sep. 3, 2015), which is hereby incorporated by reference in its entirety.

### BACKGROUND

In the new technological age, the security of personal information is an important concern. As a result, several business industries, such as financial institutions, have taken precautionary measures to ensure the safety and protection of their customers' information. A recent development is tokenization of accounts, whereby one or more secure tokens or payment credentials are assigned to an account and represent the account in transactions. The token can be reconfigured or changes on a periodic basis, and in some instances, an individual token may have a one-time use. As tokens can be changed and altered issues may arise for a customer as to management of token credentials for one or multiple accounts.

### BRIEF SUMMARY

Embodiments of the invention are directed to systems, apparatuses, methods and computer program products for electronic collection, display and association of one or more payment credentials by providing an integrated digital wallet management interface, whereby the system provides a comprehensive management platform for managing multiple digital wallets and their associated payment credentials. In some embodiments the apparatuses and systems comprise at least one memory; at least one processor; and a module stored in the memory, executable by the at least one processor, and configured to cause the at least one processor to: initiate presentation of the integrated digital wallet management interface for display on a mobile device associated with a user; receive a user input via the integrated digital wallet management interface, wherein the user input comprises one or more conditions to retrieve information associated with the one or more payment credentials; establish a communication link with a storage location associated with each of the one or more payment credentials; retrieve the information associated with the one or more payment credentials from each of the storage locations via the communication link, wherein the information comprises one or more digital wallets associated with the one or more payment credentials; and initiate presentation of one or more representations of the one or more payment credentials on the integrated digital wallet management interface and at least one indication of which of the one or more digital wallets are associated with each of the one or more payment credentials.

In some embodiments, the storage location associated with the one or more payment credentials comprises at least a cloud storage, an external memory device, an internal memory device associated with the mobile device, and a subscriber identification module (SIM) card associated with the mobile device.

In some embodiments, the system is further configured to cause the at least one processor to receive a user selection of at least one digital wallet and/or at least one payment credential from the one or more representations of the one or more payment credentials; and receive user input setting a usage limit for the at least one digital wallet and/or the at least one payment credential via the integrated digital wallet management interface.

In some embodiments, the usage limit is a threshold spending limit for an aggregation of all the payment credentials associated with the at least one digital wallet.

In some embodiments, the usage limit is a threshold spending limit to be applied to each of the payment credentials associated with the at least one digital wallet individually.

In some embodiments, the usage limit is a threshold number of transactions for an aggregation of all the payment credentials associated with the at least one digital wallet.

In some embodiments, the usage limit is a threshold number of transactions applied to each of the payment credentials associated with the at least one digital wallet individually.

In some embodiments, the usage limit is a timing limit to be applied to an aggregation of all the payment credentials associated with the at least one digital wallet.

In some embodiments, the usage limit is a timing limit to be applied to each of the payment credentials associated with the at least one digital wallet.

In some embodiments, the integrated digital wallet management interface is accessed by a user authenticated through an online banking session administered by a financial institution also administering the digital wallet.

In some embodiments, the system is further configured to cause the at least one processor to receive a user selection of at least one digital wallet associated with an indirect user; and transmit at least one transfer payment credential to the at least one digital wallet associated with the indirect user via the integrated digital wallet management interface.

In some embodiments, the transfer payment credential comprises one or more transaction limits, wherein the one or more transaction limits comprise monetary limits, geographic limits and time period limits.

In some embodiments, the one or more representations of the at least one payment credential comprises a graphical object representing the at least one payment credential; the at least one representation of the at least one digital wallet comprises a graphical object representing the at least one digital wallet; and the at least one indication comprises a graphical link between the graphical object representing the at least one payment credential and the graphical object representing the at least one digital wallet. In some such embodiments, the graphical link comprises an overlap of the graphical object representing the at least one payment credential with the graphical object representing the at least one digital wallet.

In some embodiments, the system is further configured to receive user input selecting one of the at least one representations of the at least one payment credential; and receive user input selecting one of the at least one digital wallets for association with the selected at least one payment credential. In some such embodiments, the module is further configured to initiate presentation of the selected payment credential and the selected digital wallet and at least one indication of association between the selected payment credential and the selected digital wallet.

### BRIEF DESCRIPTION OF THE DRAWINGS

Having thus described embodiments of the invention in general terms, reference will now be made to the accompanying drawings, where:

FIG. 1 is a diagram illustrating a token system, in accordance with embodiments of the present invention;

FIG. 2 is a diagram illustrating a token system, in accordance with embodiments of the present invention;

FIG. 3 is a diagram illustrating a token system, in accordance with embodiments of the present invention;

FIG. 4 is a diagram illustrating an environment in which systems according to embodiments of the invention operate;

FIG. 5 is a representation of an interface for managing digital wallets according to embodiments of the invention;

FIG. 6 is a flowchart illustrating a method for digital wallet management according to embodiments of the invention;

FIG. 7 is a flowchart illustrating a method for digital wallet management according to embodiments of the invention;

FIG. 8 is a flowchart illustrating a method for digital wallet management according to embodiments of the invention;

FIG. 9 is a payment credential dashboard displayed on an integrated interface according to one embodiment of the invention; and

FIG. 10 is a payment credential dashboard displayed on an integrated interface according to another embodiment of the invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

In accordance with embodiments of the invention, the term “financial transaction” or “transaction” refers to any transaction involving directly or indirectly the movement of monetary funds through traditional paper transaction processing systems (i.e. paper check processing) or through electronic transaction processing systems. Typical financial transactions include point of sale (POS) transactions, automated teller machine (ATM) transactions, internet transactions, online shopping, electronic funds transfers (EFT) between accounts, transactions with a financial institution teller, personal checks, etc. When discussing that transactions are evaluated it could mean that the transaction has already occurred, is in the processing of occurring or being processed, or it has yet to be processed by one or more financial institutions. In some embodiments of the invention, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments and the like.

An “entity” as used herein may be a financial institution. In accordance with embodiments of the invention, the term “financial institution” refers to any organization in the business of providing financial services, transferring, investing, or lending money, dealing in financial instruments, or services that involve monetary transactions. This includes commercial banks, thrifts, federal and state savings banks, savings and loan associations, credit unions, investment companies, merchants, insurance companies and the like. In some embodiments, the entity may allow a user to establish an account with the entity. An “account” may be the relationship that the user has with the entity. Examples of accounts include a deposit account, such as a transactional account (e.g. a banking account), a savings account, an investment account, a money market account, a time deposit, a demand deposit, a pre-paid account, a credit account, a non-monetary user profile that includes only personal information associated with the user, or the like. The account is associated with and/or maintained by an entity. In some embodiments, the entity may provide one or more financial instruments to the user for executing financial transactions. In some embodiments, the financial instruments like credit cards, debit cards, checks, account identifiers, routing numbers, passcodes and the like are associated with one or more accounts of the user. In other embodiments, an “entity” may not be a financial institution. In some embodiments, an entity may be any institution, group, association, club, establishment, company, union, authority or the like with which a user may have a relationship. In some embodiments, the entity represents a vendor or a merchant with whom the user engages in financial (for example: purchases, payments, returns, enrolling in merchant accounts and the like) or non-financial transactions (for example: loyalty programs and the like), either online or in physical stores.

In accordance with embodiments of the invention the terms “customer” and “user” and “consumer” may be interchangeable. These terms may relate to a direct customer of the financial institution or person or entity that has authorization to act on behalf of the direct customer, user, or consumer (i.e., indirect customer). In some embodiments, the direct customer may provide one or more financial instruments associated with the direct customer to one or more indirect customers or entities for the purpose of executing transactions.

Various embodiments of the present invention relate to tokenization, which is generally described in the area of financial transactions as utilizing a “token” (e.g., an alias, substitute, surrogate, or other like token identifier) as a replacement for sensitive account information, and in particular account numbers. As such, tokens or portions of tokens may be used as a stand in for a user account number, user name, pin number, routing information related to the financial institution associated with the account, security code, or other like information relating to the user account. The one or more tokens may then be utilized as a payment instrument to complete a transaction. The one or more tokens may be associated with one or more payment devices directly or within one or more digital wallets associated with the payment devices. In other embodiments, the tokens may be associated with electronic transactions that are made over the internet instead of using a physical payment device. Utilizing a token as a payment instrument instead of actual account information, and specifically an account number, improves security, and provides flexibility and convenience in controlling the transactions, controlling accounts used for the transactions, and sharing transactions between various users.

Tokens may be single-use instruments or multi-use instruments depending on the types of controls (e.g., limits) initiated for the token, and the transactions in which the token is used as a payment instrument. Single-use tokens may be utilized once, and thereafter disappear, are replaced, or are erased, while multi-use tokens may be utilized more than once before they disappear, are replaced, or are erased.

Tokens may be 16-digit numbers (e.g., like credit, debit, or other like account numbers), may be numbers that are less than 16-digits, or may contain a combination of numbers, symbols, letters, or the like, and be more than, less than, or equal to 16-characters. In some embodiments, the tokens may have to be 16-characters or less in order to be compatible with the standard processing systems between merchants, acquiring financial institutions (e.g., merchant financial institution), card association networks (e.g., card processing companies), issuing financial institutions (e.g., user financial institution), or the like, which are used to request authorization, and approve or deny transactions entered into between a merchant (e.g., a specific business or individual user) and a user. In other embodiments of the invention, the tokens may be other types of electronic information (e.g., pictures, codes, or the like) that could be used to enter into a transaction instead of, or in addition to, using a string of characters (e.g., numbered character strings, alphanumeric character strings, symbolic character strings, combinations thereof, or the like). In some embodiments, the tokens may vary depending on the type of account information being tokenized. For example, tokens directed to a user account may comprise two or more parts, each reflecting an account identifier like account number and routing number. Tokens directed to a credit card may comprise a single part reflecting the credit card number or may comprise multiple parts also reflecting other card details like CVV number and the expiration date in addition to the credit card number. In some embodiments, the tokens are device-specific and are unique to a particular device of the user and may comprise at least a portion of the device identifier of the user device. For example, the user may have multiple tokens directed to a single account stored on/used with one or more devices. The tokens used with/stored in each of the one or more devices may be distinct and device specific, even though the tokens are associated with the same user account.

A user may have one or more digital wallets on the user's payment device. The digital wallets may be associated specifically with the user's financial institution, or in other embodiments may be associated with a specific merchant, group of merchants, or other third parties. The user may associate one or more user accounts (e.g., from the same institution or from multiple institutions) with the one or more digital wallets. In some embodiments, instead of the digital wallet storing the specific account number associated with the user account, the digital wallet may store a token or allow access to a token (e.g., provide a link or information that directs a system to a location of a token), in order to represent the specific account number during a transaction. In other embodiments of the invention, the digital wallet may store some or all of the user account information (e.g., account number, user name, pin number, or the like), including the user account number, but presents the one or more tokens instead of the user account information when entering into a transaction with a merchant. The merchant may be a business, a person that is selling a good or service (hereinafter “product”), or any other institution or individual with which the user is entering into a transaction.

The digital wallet may be utilized in a number of different ways. For example, the digital wallet may be a device digital wallet, a cloud digital wallet, an e-commerce digital wallet, or another type of digital wallet. In the case of a device digital wallet the tokens are actually stored on the payment device. When the device digital wallet is used in a transaction the token stored on the device is used to enter into the transaction with the merchant. With respect to a cloud digital wallet the device does not store the token, but instead the token is stored in the cloud of the provider of the digital wallet (or another third party). When the user enters into a transaction with a merchant, transaction information is collected and provided to the owner of the cloud to determine the token, and thus, how the transaction should be processed. In the case of an e-commerce digital wallet, a transaction is entered into over the Internet and not through a point of sale terminal. As was the case with the cloud digital wallet, when entering into a transaction with the merchant over the Internet the transaction information may be captured and transferred to the wallet provider (e.g., in some embodiments, this may be the merchant or another third party that stores the token), and the transaction may be processed accordingly.

Specific tokens, in some embodiments, may be tied to a single user account, but in other embodiments, may be tied to multiple user accounts, as will be described throughout this application. In some embodiments, a single token could represent multiple accounts, such that when entering into a transaction the user may select the token (or digital wallet associated with the token) and select one of the one or more accounts associated with the token in order to allocate the transaction to a specific account. In still other embodiments, after selection of the token by the user the system may determine the best account associated with the token to use during the transaction (e.g., most cash back, most rewards points, best discount, prior usage or the like). In addition, the tokens may be associated with a specific digital wallet or multiple digital wallets as desired by the institutions or users.

Moreover, the tokens themselves, or the user accounts, individual users, digital wallets, or the like associated with the tokens, may have limitations that limit the transactions that the users may enter into using the tokens. The limitations may include, limiting the transactions of the user to a single merchant, a group of multiple merchants, merchant categories, single products, a group a products, product categories, transaction amounts, transaction numbers, geographic locations, time limits or other like limits, either alone or in combination, as is described herein.

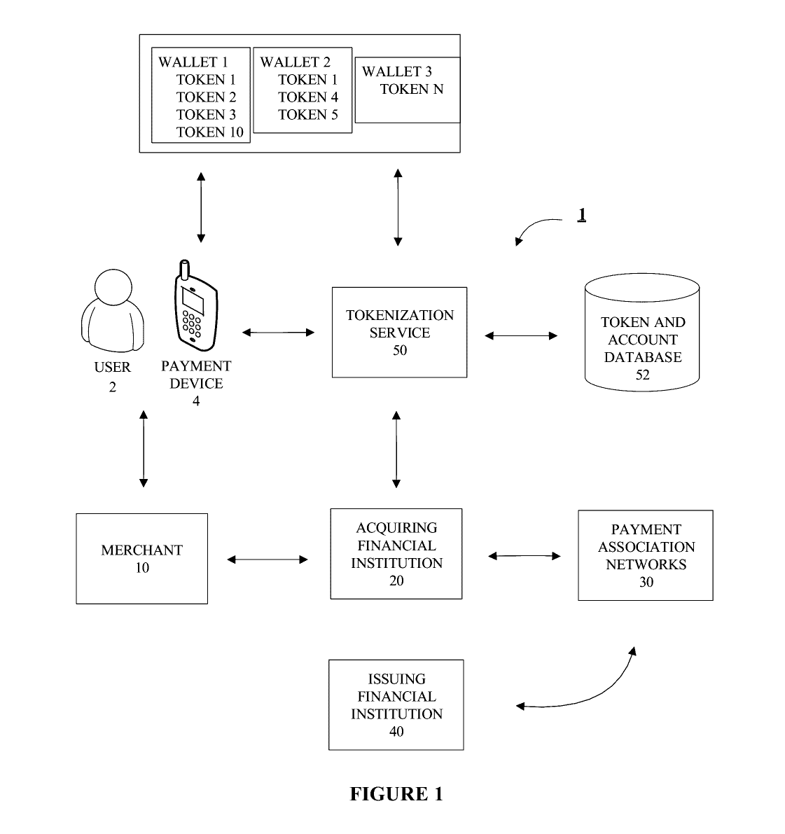

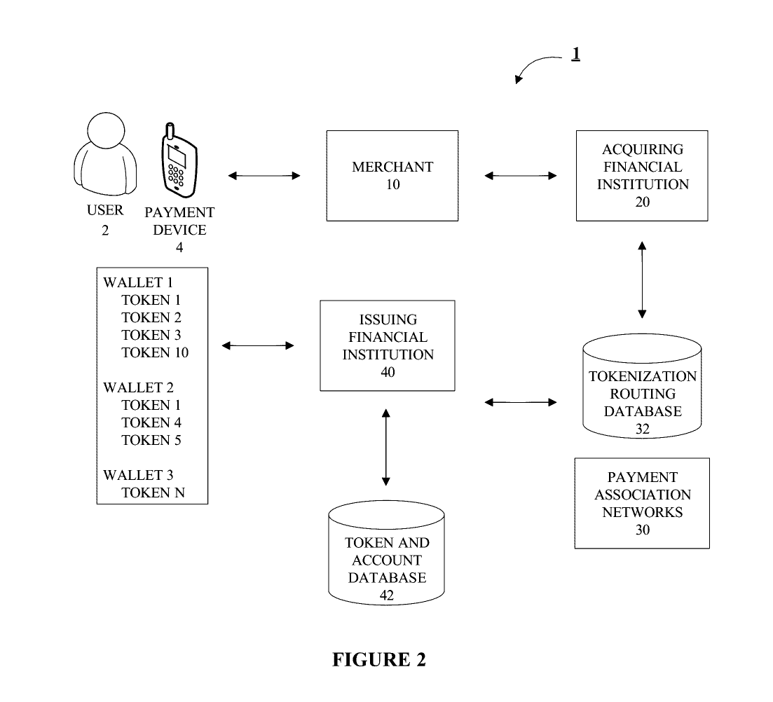

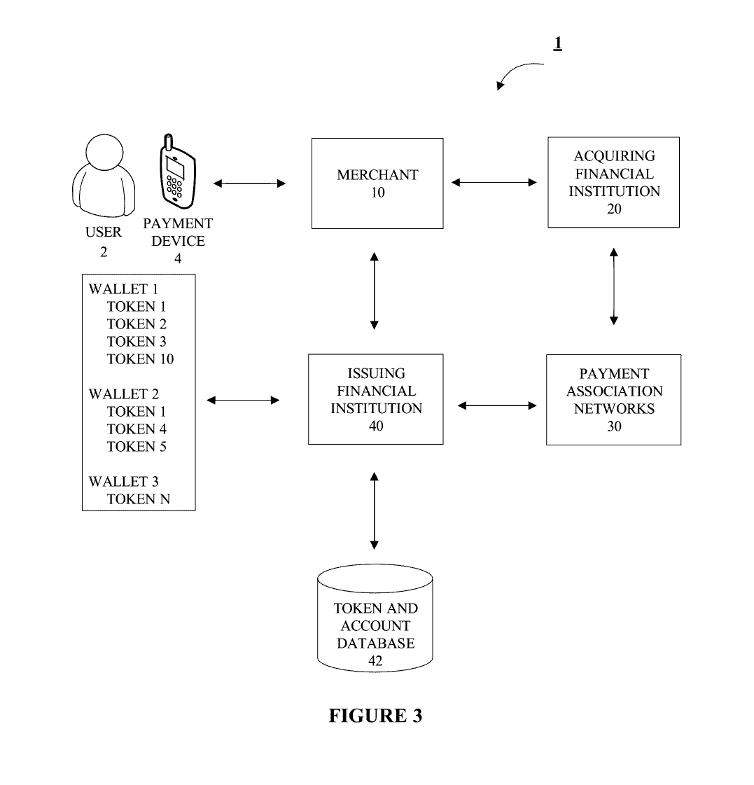

FIGS. 1 through 3 illustrate a number of different ways that the user 2 may use one or more tokens in order to enter into a transaction, as well as how the parties associated with the transaction may process the transaction. FIG. 1, illustrates one embodiment of a token system process 1, wherein the token system process 1 is used in association with a tokenization service 50. The tokenization service 50 may be provided by a third-party institution, the user's financial institution, or another institution involved in a transaction payment process. As illustrated in FIG. 1 (as well as in FIGS. 2 and 3), a user 2 may utilize a payment device 4 (or in other embodiments a payment instrument over the Internet) to enter into a transaction. FIG. 1 illustrates the payment device 4 as a mobile device, such as a smartphone, personal digital assistant, or other like mobile payment device. Other types of payment devices 4 may be used to make payments, such as but not limited to an electronic payment card, key fob, a wearable payment device (e.g., watch, glasses, or the like), or other like payment devices 4. As such, when using a payment device 4 the transaction may be made between the point of sale (POS) and the payment device 4 by scanning information from the payment device 4, using near field communication (NFC) between the POS and the payment device 4, using wireless communication between the POS and the payment device 4, or using another other type of communication between the POS and the payment device 4. When entering into an e-commerce transaction over the Internet, for example using the payment device 4 or another device without a POS, a payment instrument (e.g., a payment application that stores the token) may be used to enter into the transaction. The payment instrument may be the same as the token or digital wallet associated with the payment device 4, except they are not associated with specific payment device. For example, the token or digital wallet may be associated with a payment application that can be used regardless the device being used to enter into the transaction over the Internet.

The token can be associated directly with the payment device 4, or otherwise, through one or more digital wallets associated with the payment device 4. For example, the token may be stored on one or more payment devices 4 directly, and as such any transaction entered into by the user 2 with the one or more payment devices 4 may utilize the token. Alternatively, the payment device 4 may have one or more digital wallets stored on the payment device 4 that allow the user 2 to store one or more user account numbers, or tokens associated with the user account numbers, on the one or more digital wallets. The user may select a digital wallet or account within the digital wallet in order to enter into a transaction using a specific type of customer account. As such, the digital wallets may be associated with the user's issuing financial institutions 40, other financial institutions, merchants 10 with which the user enters into transactions, or a third party institutions that facilitates transactions between users 2 and merchants 10.

As illustrated in FIG. 1, a tokenization service 50 may be available for the user 2 to use during transactions. As such, before entering into a transaction, the user 2 may generate (e.g., create, request, or the like) a token in order to make a payment using the tokenization service 50, and in response the tokenization service 50 provides a token to the user and stores an association between the token and the user account number in a secure token and account database 52. In some embodiments the tokenization service may provide the user with a token in encrypted form for added security, such that only intended recipients (for example: tokenization service 50, issuing financial institution 20, payment device 4 or the like) may identify and/or decrypt the token data. The token may be stored in the user's payment device 4 (e.g., on the digital wallet) or stored on the cloud or other service through the tokenization service 50. The tokenization service 50 may also store limits (e.g., geographic limits, transaction amount limits, merchant limits, product limits, any other limit described herein, or the like) associated with the token that may limit the transactions in which the user 2 may enter. The limits may be placed on the token by the user 2, or another entity (e.g., client, administrator, person, company, or the like) responsible for the transactions entered into by the user 2 using the account associated with the token. The generation of the token may occur at the time of the transaction or well in advance of the transaction, as a one-time use token or multi-use token.

After or during creation of the token the user 2 enters into a transaction with a merchant 10 using the payment device 4 (or payment instrument over the Internet). In some embodiments, the user 2 may use the payment device 4 by itself, or specifically select a digital wallet or user account stored within the digital wallet, to use in order to enter into the transaction. The token associated with payment device, digital wallet, or user account within the wallet is presented to the merchant 10 as payment in lieu of the actual user account number and/or other user account information. The merchant 10 receives the token, multiple tokens, and/or additional user account information for the transaction. The merchant 10 may or may not know that the token being presented for the transaction is a substitute for a user account number or other user account information. The merchant also captures transaction information (e.g., merchant, merchant location, transaction amount, product, or the like) related to the transaction in which the user 2 is entering with the merchant 10.

The merchant 10 submits the token (as well as any user account information not substituted by a token) and the transaction information for authorization along the normal processing channels (also described as processing rails), which are normally used to process a transaction made by the user 2 using a user account number. In one embodiment of the invention the acquiring financial institution 20, or any other institution used to process transactions from the merchant 10, receives the token, user account information, and transaction information from the merchant 10. The acquiring financial institution 20 identifies the token as being associated with a particular tokenization service 50 through the token itself or user account information associated with the token. For example, the identification of the tokenization service 50 may be made through a sub-set of characters associated with the token, a routing number associated with the token, device information associated with the token, other information associated with the token (e.g., tokenization service name), or the like. The acquiring financial institution 20 may communicate with the tokenization service 50 in order to determine the user account number associated with the token. The tokenization service 50 may receive the token and transaction data from the acquiring financial institution 20, and in response, provide the acquiring financial institution 20 the user account number associated with the token as well as other user information that may be needed to complete the transaction (e.g., user name, issuing financial institution routing number, user account number security codes, pin number, or the like). In other embodiments, if limits have been placed on the token, the tokenization service 50 may determine whether or not the transaction information meets the limits and either allows or denies the transaction (e.g., provides the user account number or fails to provide the user account number). The embodiment being described occurs when the token is actually stored on the payment device 4. In other embodiments, for example, when the actual token is stored in a cloud the payment device 4 may only store a link to the token or other token information that allows the merchant 10 or acquiring financial institution to acquire the token from a stored cloud location.

If the acquiring financial institution 20 receives the user account number from the tokenization service 50 (e.g., the tokenization service indicates that the transaction meets the limits), then the acquiring financial institution 20 thereafter sends the user account number, the other user information, and the transaction information directly to the issuing financial institution 40, or otherwise indirectly through the card association networks 30. The issuing financial institution 40 determines if the user 2 has the funds available to enter into the transaction, and if the transaction meets other limits on the user account, and responds with approval or denial of the transaction. The approval runs back through the processing channels until the acquiring financial institution 20 provides approval or denial of the transaction to the merchant 10 and the transaction between the merchant 10 and the user 2 is completed. After the transaction is completed the token may be deleted, erased, or the like if it is a single-use token, or stored for further use if it is a multi-use token. In some embodiments, a multi-use token may be accompanied by or may include unique passcodes generated for every transaction. In this regard a key may be used to generate dynamic security codes for each transaction.

Instead of the process described above, in which the acquiring financial institution 20 requests the token from the tokenization service 50, in some embodiments, the tokenization service 50 may receive the transaction request and transaction information from the merchant 10 or acquiring financial institution 20. Instead of providing the account number to the acquiring financial institution 20, the tokenization service 50 may send the transaction request and transaction information to the issuing financial institution 40 directly, or indirectly through the payment association networks 30.

The embodiment illustrated in FIG. 1 prevents the user account number and other user information from being presented to the merchant 10; however, the tokenization service 50, acquiring financial institution 20, the card association networks 30, and the issuing financial institution 40 may all utilize the actual user account number and other user information to complete the transaction.

FIG. 2 illustrates another embodiment of a token system process 1, in which the user 2 may utilize a payment device 4 (or payment instrument over the Internet) to enter into transactions with merchants 10 utilizing tokens instead of user account numbers. As illustrated in FIG. 2, the user may have one or more tokens, which may be associated with the payment device 4, one or more digital wallets within the payment device 4, or one or more user accounts associated with the digital wallets. The one or more tokens may be stored in the user's payment device 4 (or on the digital wallet), or stored on a cloud or other service through the issuing financial institution 40 or another institution. The user 2 may set up the digital wallet by communicating with the issuing financial institution 40 (e.g., the user's financial institution) to request a token for the payment device, either for the device itself, or for one or more digital wallets or one or more user accounts stored on the payment device. As previously discussed, a wallet may be specifically associated with a particular merchant (e.g., received from the merchant 10) and include one or more tokens provided by the issuing financial institution 40 directly (or through the merchant as described with respect to FIG. 3). In other embodiments, the issuing financial institution 40 may create the digital wallet for the user 2 (e.g., through a wallet created for a business client or retail client associated with the user 2) and include one or more tokens for various types of transactions, products, or the like. The issuing financial institution 40 may store the tokens, the associated user account information (e.g., including the user account number), and any limits on the use of the tokens, as was previously described with respect to the tokenization service 50 in FIG. 1. In one embodiment the tokens may include user account information or routing information within the token or tied to the token, which allows the merchants 10 and other institutions in the payment processing systems to route the token and the transaction information to the proper institutions for processing. In other embodiments a tokenization routing database 32 may be utilized to determine where to route a transaction using a token, as described in further detail later.

The user 2 may enter into a transaction with the merchant 10 using a payment device 4 (or a payment instrument through the Internet). In one embodiment the user 2 may enter into the transaction with a token associated with the payment device 4 itself (or a payment instrument through the Internet). In other embodiments, a specific digital wallet and/or a specific account within the digital wallet may be selected for a particular merchant with whom the user 2 wants to enter into a transaction. For example, the user 2 may select “wallet 1” to enter into a transaction with “merchant 1” and “token 1” to utilize a specific account. The merchant 10 identifies the token, and sends the token and the transaction information to the acquiring financial institution 20. If the token has routing information the acquiring financial institution 20 may route the token and transaction data to the issuing financial institution 40 directly or through the card association networks 30. In situations where the token does not have associated routing information, the acquiring financial institution 20 may utilize a tokenization routing database 32 that stores tokens or groups of tokens and indicates to which issuing financial institutions 40 the tokens should be routed. One or more of the acquiring financial institutions 20, the card association networks 30, and/or the issuing financial institutions 40 may control the tokenization routing database in order to assign and manage routing instructions for tokenization across the payment processing industry. The tokenization routing database 32 may be populated with the tokens and the corresponding issuing financial institutions 40 to which transactions associated with the tokens should be routed. However, in some embodiments, no customer account information would be stored in this tokenization routing database 32, only the instructions for routing particular tokens may be stored.

Once the token and transaction details are routed to the issuing financial institution 40, the issuing financial institution 20 determines the user account associated with the token through the use of the token account database 42. The financial institution determines if the funds are available in the user account for the transaction and if the transaction information meets other limits by comparing the transaction information with the limits associated with the token, the user account associated with the token, or other limits described herein. If the transaction meets the limits associated with the token or user account, then the issuing financial institution 20 allows the transaction. If the transaction information does not meet one or more of the limits, then the issuing financial institution 20 denies the transaction. The issuing financial institution sends a notification of the approval or denial of the transaction back along the channels of the transaction processing system to the merchant 10, which either allows or denies the transaction.

The embodiment illustrated in FIG. 2 allows the user and the financial institution to shield the user's account number and other user information from all of the entities in the payment processing system because the merchant 10, acquiring merchant bank 20, payment association networks 30, or other institutions in the payment processing system only use the token and/or other shielded user information to process the transaction. Only the issuing financial institution 40 has the actual account number of the user 2.

FIG. 3 illustrates another embodiment of the token system process 1, in which the user 2 may utilize a payment device 4 (or payment instrument over the Internet) to enter into transactions with a merchant 10 utilizing a token instead of a user account number and/or other user account information. As illustrated in FIG. 3, the user 2 may have one or more tokens associated with the payment device 2, the one or more digital wallets, or one or more user accounts within the digital wallets. The one or more tokens may be stored in the user's payment device 4 (or within the digital wallet), or stored on a cloud or other service through the issuing financial institution 40 or another institution. The user 2 may set up the digital wallet by communicating with the issuing financial institution 40 (e.g., the user's financial institution) and/or the merchant 10 to request a token for the payment device 4, either for the payment device 4 itself, for the one or more digital wallets stored on the payment device 4, or for user accounts within the digital wallet. The financial institution 40 may have a dedicated group of tokens that are associated with a specific merchant, and as such the merchant 10 and the issuing financial institution 40 may communicate with each other to provide one or more tokens to the user 2 that may be specifically associated with the merchant 10. For example, the issuing financial institution may provide a set of tokens to “merchant 1” to associate with “wallet 1” that may be used by one or more users 2. As such “Token 10” may be associated with “wallet 1” and be specified only for use for transactions with “merchant 1.”

The merchant 10 may provide the specific tokens from the financial institution 40 to the user 2, while the financial institution 40 may store the user account information with the token provided to the user 2. The financial institution may communicate directly with the user 2, or through the merchant 10 in some embodiments, in order to associate the token with the user 2. Since the merchant 10 provides, or is at least notified by the financial institution 40, that a specific token, or groups of tokens, are associated with a specific issuing financial institution 40, then the merchant 10 may associate routing information and transaction information with the token when the user 2 enters into a transaction with the merchant 10 using the token.

The merchant 10 passes the token (and potentially other user account information), routing information, and transaction information to the acquiring financial institution 20 using the traditional payment processing channels. The acquiring financial institution 20, in turn, passes the token (and potentially other user account information) and transaction information to the issuing financial institution 40 directly, or indirectly through the payment association networks 30 using the routing information. The issuing financial institution 40 accesses the token and account database 42 to identify the user account associated with the token and determines if the transaction information violates any limits associated with the token or the user account. The issuing financial institution 40 then either approves or denies the transaction and sends the approval or denial notification back through the payment processing system channels to the merchant 10, which then notifies the user 2 that the transaction is allowed or denied.

As is the case with the token system process 1 in FIG. 2, the token system process 1 in FIG. 3 allows the user 2 and the financial institution 40 to shield the user's account number and other user information from all of the entities in the payment processing system because the merchant 10, acquiring merchant bank 20, payment association networks 30, or other institutions in the payment processing system only use the token and/or other shielded user information to process the transaction. Only the issuing financial institution 40 has the actual account number of the user 2.

The embodiments of the invention illustrated in FIGS. 1 through 3 are only example embodiments of the invention, and as such it should be understood that combinations of these embodiments, or other embodiments not specifically described herein may be utilized in order to process transactions between a user 2 and merchant 10 using one or more tokens as a substitute for user account numbers or other user account information, such that the merchant 10, or other institutions in the payment processing system do not have access to the actual user accounts or account information.

As briefly discussed above, if the issuing financial institution 40 creates the digital wallet not only does the issuing financial institution 40 receive transaction information along the normal processing channels, but the financial institution 50 may also receive additional transaction information from the user 2 through the digital wallet using the application program interfaces (APIs) or other applications created for the digital wallet. For example, geographic location information of the user 2, dates and times, product information, merchant information, or any other information may be transmitted to the issuing financial institution 40 through the APIs or other applications to the extent that this information is not already provided through the normal transaction processing channels. This additional transaction information may assist in determining if the transactions meet or violate limits associated with the tokens, user accounts, digital wallets, or the like.

Alternatively, if the merchant 10 or another institution, other than the issuing financial institution 40, provides the digital wallet to the user 2, the issuing financial institution 40 may not receive all the transaction information from the traditional transaction processing channels or from the digital wallet. As such, the issuing financial institution 40 may have to receive additional transaction information from another application associated with the user 2 and compare the transaction information received through the traditional channels in order to associate the additional information with the transaction. In other embodiments, the issuing financial institutions 40 may have partnerships with the merchants 10 or other institutions to receive additional transaction information from the digital wallets provided by the merchants or other institutions when the users 2 enter into transactions using the digital wallets.

Moreover, when there is communication between the digital wallets of the users 2 and the issuing financial institution 40 or another institution, transactions in which the user 2 may enter may be pre-authorized (e.g., pre-qualified) to determine what accounts (e.g., tokens) may be used to complete the transaction, without having to arbitrarily choose an account for the transaction. In the case when there are multiple digital wallets or multiple accounts, the account that is pre-authorized or the account that provides the best rewards may be automatically chosen to complete the transactions.

Additional embodiments of the invention will now be described in further detail in order to provide additional concepts and examples related to how tokens may be utilized in these illustrated token system processes 1 or in other token system processes not specifically described in FIGS. 1 through 3.

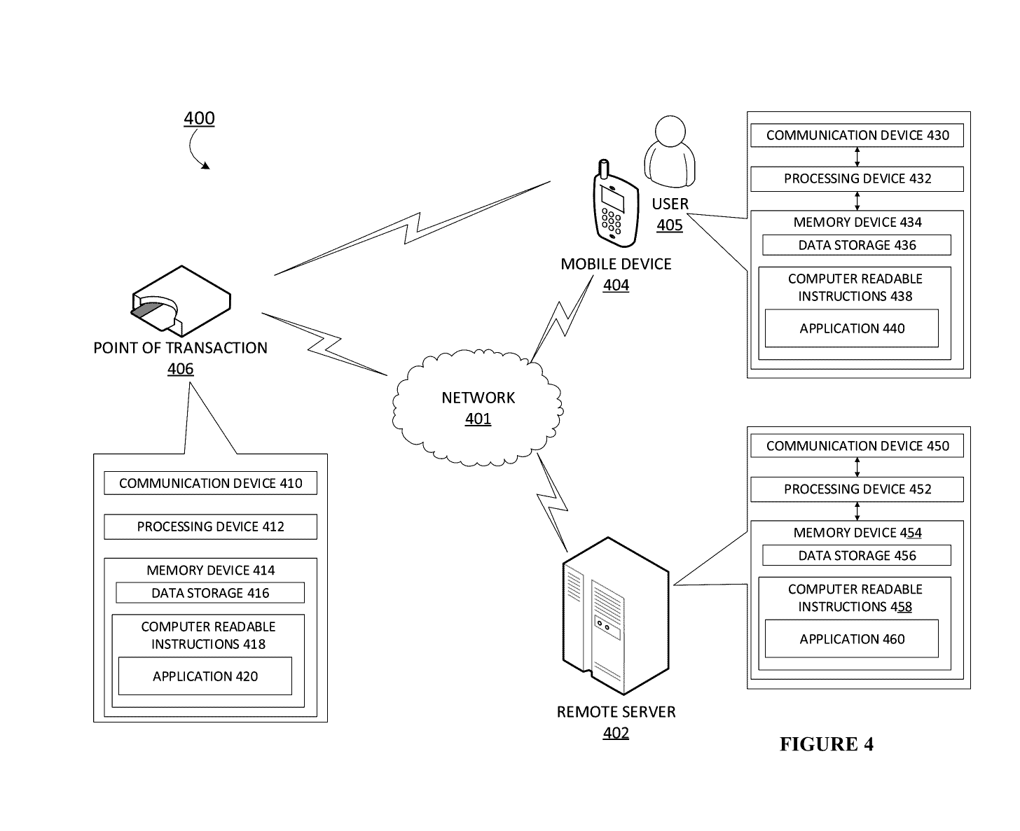

Referring to FIG. 4, a network environment is illustrated in accordance with embodiments of the present invention. As illustrated in FIG. 4, the remote server 402 is operatively coupled via a network 401 to the mobile device 404 and/or a point of transaction (POT) 406. In this configuration, the remote server 402 may send information to and receive information from the mobile device 404, the POT 406 and/or other systems associated with merchants, issuing financial institutions, acquiring financial institutions, payment association networks, tokenization services and the like. Additionally, the mobile device 404 may send and receive communications directly from the POT 406. The remote server 402 may be or include one or more network base stations or other network components. FIG. 4 illustrates only one example of an embodiment of a network environment 400, and it will be appreciated that in other embodiments one or more of the systems, devices, or servers may be combined into a single system, device, or server, or be made up of multiple systems, devices, or server.

The network 401 may be a global area network (GAN), such as the Internet, a wide area network (WAN), a local area network (LAN), a telecommunication network or any other type of network or combination of networks. The network 401 may provide for wireline, wireless, or a combination wireline and wireless communication between devices on the network 401. In some embodiments, the user 405 is an individual who maintains cellular products with one or more providers.

As illustrated in FIG. 4, the remote server 402 generally comprises a communication device 450, a processing device 452, and a memory device 454. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combination of the foregoing. Control and signal processing functions of the system are allocated between these processing devices according to their respective capabilities. The processing device may include functionality to operate one or more software programs based on computer readable instructions thereof, which may be stored in a memory device.

The processing device 452 is operatively coupled to the communication device 450 to communicate with the network 401 and other devices on the network 401. As such, the communication device 450 generally comprises a modem, server, or other device for communicating with other devices on the network 401.

As further illustrated in FIG. 4, the network remote server 402 comprises computer readable instructions 458 of an application 460. In some embodiments, the memory device, 454 includes data storage 456 for storing data related to and/or used by the application 460. The application 460 may perform one or more of the steps and/or sub-steps discussed herein and/or one or more steps not discussed herein. For example, in some embodiments, the application 460 may initiate presentation of an interface for digital wallet management.

As illustrated in FIG. 4, the mobile device 404 generally comprises a communication device 430, a processing device 432, and a memory device 434. The processing device 432 is operatively coupled to the communication device 430 and the memory device 434. In some embodiments, the processing device 432 may send or receive data from the mobile device 404, to the remote server 402 via the communication device 430 over a network 401. As such, the communication device 430 generally comprises a modem, server, or other device for communicating with other devices on the network 401.

As further illustrated in FIG. 4, the mobile device 404 comprises computer readable instructions 438 stored in the memory device 434, which in some embodiments, includes the computer-readable instructions 438 of an application 440. In the embodiment illustrated in FIG. 4, the application 440 allows the mobile device 404 to be linked to the remote server 402 to communicate, via a network 401. The application 440 may also allow the mobile device to connect directly (i.e. locally or device to device) with the POT 406 for performing a transaction. The application 440 may perform one or more of the steps and/or sub-steps discussed herein and/or one or more steps not discussed herein. For example, in some embodiments, the application 440 may initiate presentation of an interface for digital wallet management.

As illustrated in FIG. 4, the POT 406 may include a communication device 410, a processing device 412, and a memory device 414. The processing device 412 is operatively coupled to the communication device 410 and the memory device 414. In some embodiments, the processing device 412 may send or receive data from the mobile device 404 and/or the remote server 402 via the communication device 410. Such communication may be performed either over a direct connection and/or over a network 401. As such, the communication device 410 generally comprises a modem, server, or other device for communication with other devices on the network 401.

As further illustrated in FIG. 4, the POT 406 comprises computer-readable instructions 418 of an application 420. In the embodiment illustrated in FIG. 4, the application 420 allows the ATM 406 to be linked to the remote server 402 to communicate, via a network 401. The application 420 may also allow the mobile device 406 to connect directly (i.e., locally or device to device) with the POT 406 or indirectly through the network 401. The application 420 may perform one or more of the steps and/or sub-steps discussed herein and/or one or more steps not discussed herein.

It is understood that the servers, systems, and devices described herein illustrate one embodiment of the invention. It is further understood that one of more of the server, systems, and devices can be combined in other embodiments and still function in the same or similar way as the embodiments described herein.

In various embodiments, the POT device may be or include a merchant machine and/or server and/or may be or include the mobile device of the user may function as a point of transaction device. The embodiments described herein may refer to the use of a transaction, transaction event or point of transaction event to trigger the steps, functions, routines etc. described herein. In various embodiments, occurrence of a transaction triggers the sending of information such as alerts and the like. Unless specifically limited by the context, a “transaction”, “transaction event” or “point of transaction event” refers to any communication between the user and the merchant, e.g. financial institution, or other entity performing transactions for the user. In some embodiments, for example, a transaction may refer to a purchase of goods or services, a return of goods or services, a payment transaction, a credit transaction, or other interaction involving a user's bank account. As used herein, a “bank account” refers to a credit account, a debit/deposit account, or the like. Although the phrase “bank account” includes the term “bank,” the account need not be maintained by a bank and may, instead, be maintained by other financial institutions. For example, in the context of a financial institution, a transaction may refer to one or more of a sale of goods and/or services, an account balance inquiry, a rewards transfer, an account money transfer, opening a bank application on a user's computer or mobile device, a user accessing their e-wallet or any other interaction involving the user and/or the user's device that is detectable by the financial institution. As further examples, a transaction may occur when an entity associated with the user is alerted via the transaction of the user's location. A transaction may occur when a user accesses a building, uses a rewards card, and/or performs an account balance query. A transaction may occur as a user's mobile device establishes a wireless connection, such as a Wi-Fi connection, with a point-of-sale terminal. In some embodiments, a transaction may include one or more of the following: purchasing, renting, selling, and/or leasing goods and/or services (e.g., groceries, stamps, tickets, DVDs, vending machine items, etc.); withdrawing cash; making payments to creditors (e.g., paying monthly bills; paying federal, state, and/or local taxes and/or bills; etc.); sending remittances; transferring balances from one account to another account; loading money onto stored value cards (SVCs) and/or prepaid cards; donating to charities; and/or the like.

In some embodiments, the transaction may refer to an event and/or action or group of actions facilitated or performed by a user's device, such as a user's mobile device. Such a device may be referred to herein as a “point-of-transaction device”. A “point-of-transaction” could refer to any location, virtual location or otherwise proximate occurrence of a transaction. A “point-of-transaction device” may refer to any device used to perform a transaction, either from the user's perspective, the merchant's perspective or both. In some embodiments, the point-of-transaction device refers only to a user's device, in other embodiments it refers only to a merchant device, and in yet other embodiments, it refers to both a user device and a merchant device interacting to perform a transaction. For example, in one embodiment, the point-of-transaction device refers to the user's mobile device configured to communicate with a merchant's point of sale terminal, whereas in other embodiments, the point-of-transaction device refers to the merchant's point of sale terminal configured to communicate with a user's mobile device, and in yet other embodiments, the point-of-transaction device refers to both the user's mobile device and the merchant's point of sale terminal configured to communicate with each other to carry out a transaction.

As used herein, a “user device” or “mobile device” may be a point-of-transaction device as discussed, or may otherwise be a device carried by a user configured to communicate across a network such as a cellular network, wireless fidelity network or otherwise. As used here a “user” refers to a previous customer or a non-customer of one or more merchants or entities associated with one or more merchants.

In some embodiments, a point-of-transaction device is or includes an interactive computer terminal that is configured to initiate, perform, complete, and/or facilitate one or more transactions. A point-of-transaction device could be or include any device that a user may use to perform a transaction with an entity, such as, but not limited to, an ATM, a loyalty device such as a rewards card, loyalty card or other loyalty device, a magnetic-based payment device (e.g., a credit card, debit card, etc.), a personal identification number (PIN) payment device, a contactless payment device (e.g., a key fob), a radio frequency identification device (RFID) and the like, a computer, (e.g., a personal computer, tablet computer, desktop computer, server, laptop, etc.), a mobile device (e.g., a smartphone, cellular phone, personal digital assistant (PDA) device, MP3 device, personal GPS device, etc.), a merchant terminal, a self-service machine (e.g., vending machine, self-checkout machine, etc.), a public and/or business kiosk (e.g., an Internet kiosk, ticketing kiosk, bill pay kiosk, etc.), a gaming device, and/or various combinations of the foregoing.

In some embodiments, a point-of-transaction device is operated in a public place (e.g., on a street corner, at the doorstep of a private residence, in an open market, at a public rest stop, etc.). In other embodiments, the point-of-transaction device is additionally or alternatively operated in a place of business (e.g., in a retail store, post office, banking center, grocery store, factory floor, etc.). In accordance with some embodiments, the point-of-transaction device is not owned by the user of the point-of-transaction device. Rather, in some embodiments, the point-of-transaction device is owned by a mobile business operator or a point-of-transaction operator (e.g., merchant, vendor, salesperson, etc.). In yet other embodiments, the point-of-transaction device is owned by the financial institution offering the point-of-transaction device providing functionality in accordance with embodiments of the invention described herein.

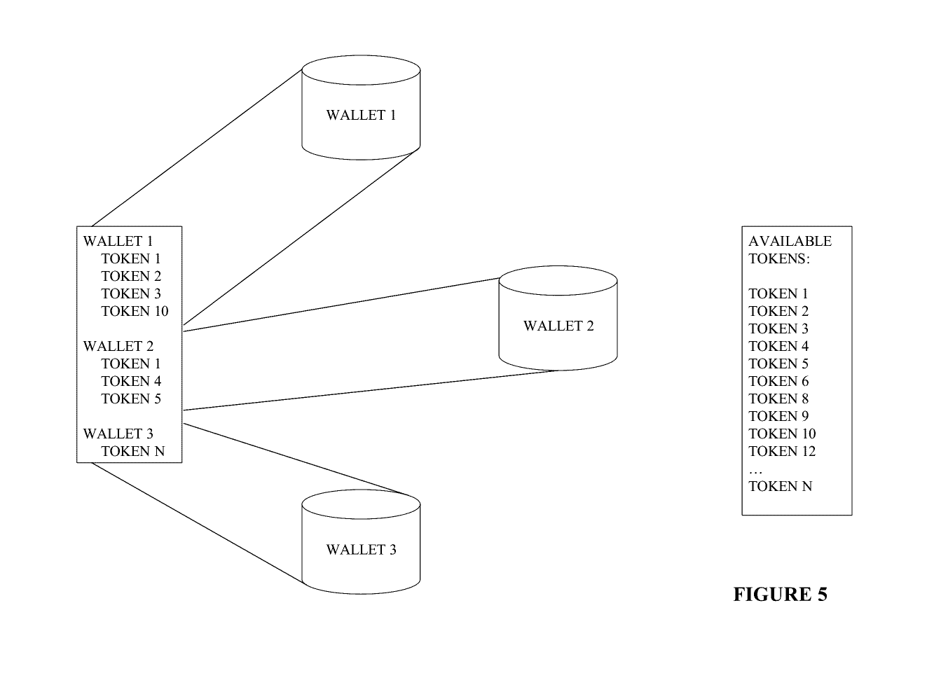

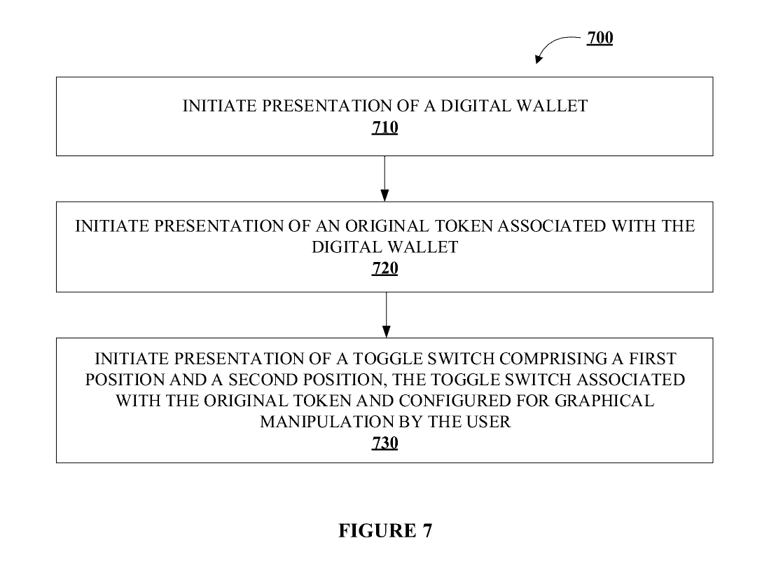

Referring now to FIG. 5, a diagram illustrates an example of an interface for managing digital wallets. The example interface illustrates a combined representation of three digital wallets associated with the mobile device of a user. As shown, each of the digital wallets has at least one associated payment credential (e.g., tokens). The tokens, as shown, are sorted into different digital wallets. As shown, each of the digital wallets is also illustrated graphically as a separate entity. Also shown is a comprehensive listing of the tokens available for usage, and therefore, available for association and/or authentication into one or more digital wallets. The customer may select a token from the available token listing and then associate it with a particular wallet by dragging it into the graphical representation of the wallet. In other embodiments, once a token and/or wallet has been selected additional functionality is available, such as that described below with reference to FIGS. 7 and/or 8.

According to embodiments of the invention, during an online banking session, a customer may use an interface to select which payment credentials (cards (credit/debit), tokens etc.) are entered into which digital wallets (e.g., Google, PayPal, apple pay etc.). In some instances, the customer is given an opportunity to set limits for each wallet, and in some cases, the customer is provided an opportunity to set timeframe limits. The customer may use an interface for visibility into everywhere a payment credential (e.g., credit/debit card) is tied for payment, recurring or otherwise. In a digital wallet, the customer may provide recurring payment information, and “push-button billpay enrollment”.

In some embodiments, the wallets may be owned and/or operated by one or more entities. In some embodiments, the wallets and/or the associated tokens may be stored at different locations. For example the wallet and one or more associated tokens may be stored on the cloud or on a server remote from the user device. As another example the wallet and the one or more associated tokens may be stored on a secure location on the user device. The secure location may be a part of the memory of the user device, for example an isolated section of the memory. In some instances the secure location may be a secure element comprising an integrated circuit chip of the user device (for example the Subscriber Identification Module (SIM) card of a phone or a tablet device). Typically the secure location and the secure element are configured to be isolated, with very limited interaction with the rest of the operating system of the user device, to maintain the security of the tokens. The tokens may be invoked for online and/or in-store purchases through appropriate channels.

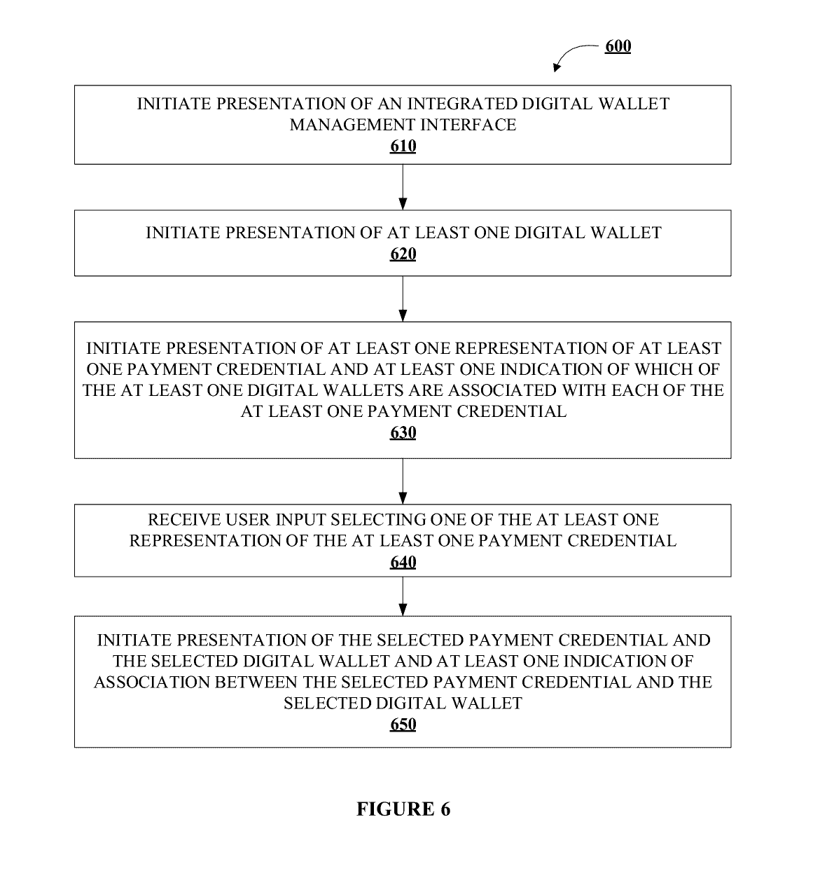

Referring now to FIG. 6, a flowchart illustrates a method 600 for digital wallet management according to embodiments of the invention.

The first step, represented by block 610, is to initiate presentation of an integrated digital wallet management interface. This interface, in some embodiments, is presented on a user device, for example a mobile device of a customer of a financial institution. The interface may comprise of visual elements, audio elements or a suitable combination of elements. In some embodiments, the interface may comprise an intelligent personal assistant and knowledge navigator configured to modify the interface or perform actions either automatically or in response to receiving commands from the user. In some embodiments, the interface may be managed and controlled by an application on the user device. In some embodiments, the interface maybe managed and controlled by the remote server, transmitting instructions to the application stored on the user device. In some embodiments, the application may continuously run in the background of the user device and may automatically initiate presentation of the interface in response to a trigger event comprising purchases, usage of tokens by an indirect user, receiving notifications/signals from a point of sale device, proximity to a point of sale device, modification of parameters associated with one or more tokens and the like. In some embodiments, the user may initiate the presentation of the interface.

The next step, represented by block 620, is to initiate presentation of at least one digital wallet. The digital wallet(s) may be presented in a variety of formats, such as a scrolling format, multiple icons, or a flip-book format where the user may turn pages or leafs associated with each digital as if turning the pages of a book. In some embodiments, the user may be associated with one or more digital wallets, the wallets being owned and/or operated by different entities and/or the wallets being stored at different locations. In this regard the system (for example the remote server 402 or the application 440) may automatically determine one or more wallets associated with the user based on retrieving information from one or more user devices, analyzing transaction history of the user, retrieving financial account activity, analyzing social media updates of the user, analyzing a user profile comprising customer information (for example, contact information) and financial information of the user and the like. In some embodiments, information associated with the wallets, for example authorization credentials, wallet identifiers and the like may be requested from the user at least for a first time, typically prior to execution of transactions. In some embodiments the presentation of at least one digital wallet at block 620 comprises presentation of an integrated interface by extracting information associated with the wallets and their tokens from their individual locations and presenting the wallets on a single interface.

In some embodiments, the integrated interface may be presented to the user in response to receiving authentication credentials from the user. In some embodiments the user may be authenticated by receiving and analyzing biometric information and physiological information of the user, for example, fingerprint scans, iris recognition, retina scans, facial recognition, hand geometry, voice recognition and the like. In some embodiments the user may be authenticated based on behavioral characteristics like device usage patterns, typing rhythm, gait, gestures, heart rate and other characteristics. In some embodiments the user may be authenticated based on pre-authenticated auxiliary devices, for example a user in continued possession of a pre-authenticated auxiliary device (for example, a wearable device) in operative communication with the user device may be authenticated based on continued monitoring of the user device and the auxiliary device. In some embodiments the user may be authenticated based on received userID and passwords. In some embodiments each of the authentication methods described above may be assigned an authorization level, and the authentication methods may be user singularly or in combination to achieve a desired level of authorization. Therefore, the user may be provided access to one or more wallets though an integrated interface in a secure and convenient manner. For example, a user may be associated with: a first wallet stored on a cloud associated with a first entity, a second wallet stored on a remote server associated with a second entity and a third wallet associated with a third entity stored in a secure element of an auxiliary user device. The system may present an integrated interface that enables the user to access and modify the payment credentials or tokens associated with the wallets without requiring the user to access the payment credentials or tokens thorough conventional channels separately and without requiring the user to provide authentication credentials separately for each channel. In this regard the system may communicate with and/or establish operative communication channels between the user device, the auxiliary user device, the cloud associated with the first entity, the servers associated with the second entity and other third party systems.

Next, represented by block 630, the system initiates presentation of at least one representation of at least one payment credential and at least one indication of which of the at least one digital wallets are associated with each of the at least one payment credential on the integrated interface. Each digital wallet may be displayed concurrently, or in some embodiments, may include presentation of only a portion of the available digital wallets, for example, only one or two digital wallets of many available digital wallets. In some embodiments, the payment credentials associated with a digital wallet may be overlaid on the associated digital wallet, on the integrated interface, thereby indicated the payment credential is associated with the digital wallet. In some cases, a payment credential may be associated with more than one digital wallet. In such a case, the payment credential may have an associated icon or representation shown with each of its associated digital wallets. In some embodiments, on the other hand, the interface is payment credential-centric, or in other words, each payment credential is shown separately and the digital wallet(s) to which the payment credential is associated are shown as objects within or otherwise associated with the payment credential. For example, a credit card icon may be shown as a window that includes multiple objects representing the various digital wallets with which the credit card is associated for use.

In some embodiments, when a payment credential is “associated with” a digital wallet, the payment credential is shown by the interface, to be connected with the digital wallet for use as a payment credential with the digital wallet. In such a case, the payment credential has been “authenticated for use” in association with the digital wallet such that the user may select the digital wallet for performing a transaction using the associated payment credential or the system may automatically determine a suitable digital wallet when the user selects the payment credential for a transaction. In some embodiments, the system may require one or more authentication steps with the financial institution that issued the payment credential or the system may utilize the authentication the user provided for the presentation of the interface to authenticate the transaction. In some embodiments the system may seek confirmation from the user before executing the transaction with the appropriate payment credential and the suitable wallet. The user may provide confirmation in the form of voice commands, swipe/touch patterns on the screen of the user device, selection of one or more options presented on the interface, gestures, authentication means described previously, movement/orientation of the user device, or any other suitable means of indication. As discussed in further detail below, a payment credential may be authenticated for use with a digital wallet but may be de-selected for use with the digital wallet by the user (i.e., it may not be associated with the digital wallet), in which case, the user would not be allowed by the system to use the payment credential in a transaction with the digital wallet regardless of the fact that it has been authenticated for use with the digital wallet. In such a case, the user can use the interface to associate the already authenticated payment credential with the digital wallet and then perform the desired transaction in real time. In this regard the system may establish an operative communication channel with the entity systems, owning/operating the digital wallet and the location of storage of the payment credential, to extract information associated with the payment credential for display on the integrated interface and to modify one or more parameters associated with the payment credential, either at the storage location of the payment credential, at the entity systems or on the user device, based on received user input.

In some embodiments, as represented by block 640, user input is received selecting one of the at least one representation of the at least one payment credential. Next, as represented by block 650, the system initiates presentation of the selected payment credential and the selected digital wallet and at least one indication of association between the selected payment credential and the selected digital wallet. In some embodiments, as discussed above, the interface may be payment credential-centric or digital wallet-centric in that either the payment credential(s) or the digital wallet(s) serve as the “bins” in which the digital wallet(s) and payment credential(s), respectively, may be manipulated. Accordingly, the user may, in some embodiments, click and drag desired icons into the desired bins in order to associate the payment credentials and digital wallets. This may trigger one or more necessary steps, such as authentication of the selected payment credential with the financial institution that issued the payment credential and/or authentication or other verification with the entity that maintains/issues/facilitates the digital wallet.

In some embodiments, one or more of the payment credentials may be “authenticated” for use with a digital wallet but may not be selected for use with the digital wallet. In such cases, the authenticated payment credentials may not be shown as associated with the digital wallet, but rather may reside in a queue bin or other bin. Some separate indicator may be used to indicate that the payment credential is authenticated for use in a digital wallet for which it is not currently associated (i.e., the digital wallet bin does not show that the payment credential is associated). In such a case, when the user selects the payment credential for association with the digital wallet, then less than full authentication or no additional authentication may be required for the payment credential to be associated with the digital wallet due to the previous authentication of the payment credential with the digital wallet.

In various embodiments, the at least one representation of the at least one payment credential includes a graphical object representing the at least one payment credential. Furthermore, in some embodiments, the at least one representation of the at least one digital wallet comprises a graphical object representing the at least one digital wallet. Similarly, in some embodiments, the at least one indication comprises a graphical link between the graphical object representing the at least one payment credential and the graphical object representing the at least one digital wallet. The graphical link, in some embodiments, may include an overlap of the graphical object representing the at least one payment credential with the graphical object representing the at least one digital wallet. In various other embodiments, the graphical link may be one or more other graphical representations of a connection or association between the payment credential and the digital wallet (e.g., one or more graphical similarities of the respective representations).

In various embodiment, the system is configured to receive user input setting a usage limit for one of the at least one digital wallets. This usage limit may be a threshold spending limit. Such a threshold spending limit may reference an aggregation of all the payment credentials associated with the digital wallet. In some instances, the usage limit is a threshold spending limit to be applied to each of the payment credentials associated with the digital wallet individually. In other cases, the usage limit is a threshold number of transactions for an aggregation of all the payment credentials associated with the digital wallet. In various embodiments, the usage limit is or includes a threshold number of transactions applied to each of the payment credentials associated with the digital wallet individually.

In various embodiments, the usage limit is a timing limit to be applied to an aggregation of all the payment credentials associated with the digital wallet. In other embodiments, the usage limit is a timing limit to be applied to each of the payment credentials associated with the digital wallet.

In some embodiments, the integrated digital wallet management interface is accessed by a customer authenticated through an online banking session administered by a financial institution also administering the digital wallet. In some embodiments, the interface is accessed by a customer authenticated through a mobile banking application session administered by a financial institution also administering the digital wallet.

According to embodiments of the invention, a customer can operate “toggles” or switches that turn on/off token functionality for various situations. For example, the customer may turn on the “travel toggle”, which indicates that the customer is traveling. A token may be changed and then, when the “toggle” is removed, the token may be changed again.

Referring now to FIG. 7, a flowchart illustrates a method 700 for token management according to embodiments of the invention. The method 700 includes, as represented by block 710, initiating presentation of a digital wallet. The next step, represented by block 720, is to initiate presentation of an original token associated with the digital wallet. Finally, as represented by block 730, the system initiates presentation of a toggle switch comprising a first position and a second position.

The toggle switch is associated with the original token and is configured for graphical manipulation by the user. The toggle switch may have a first and a second position in some embodiments, where the first position corresponds to the original token being available for use as a payment credential, and the second position corresponds to the original token being unavailable for use as a payment credential.

In various embodiments, a travel indicator may be configured such that the first position corresponds to the user not traveling and the second position corresponds to the user traveling. In some cases, when the travel indicator is moved from the first position to the second position, the original token is deactivated and a new token is issued to the digital wallet.

In some embodiments, when the travel indicator is moved from the second position to the first position, the new token is deactivated and the original token is re-activated. In some cases, when the travel indicator is moved from the second position to the first position, the new token is deactivated and the second new token is issued to the digital wallet. In some embodiments, the system destroys the original token and/or the new token.

In some embodiments, there may be multiple toggle switches associated with a single payment credential. In some cases, each of the toggle switches may be locked or immovable by the customer based on whether the financial institution or other administering entity allows the toggles to be moved in a particular situation. For example, in some cases, a toggle switch may be associated with traveling, and if it is determined the customer is not traveling (based on, e.g., GPS data), then the toggle switch may be disengaged or immovable by the customer. In some embodiments, the system may propose a particular toggle switch position to the customer via the interface. For example, when it is determined that the customer is traveling (e.g., by using GPS data), then the interface may propose that a travel toggle switch should be activated. Once the user confirms that the user is traveling, then the system activates the travel toggle switch, or in some cases, the user then activates the travel toggle switch manually.

According to embodiments of the invention, a payment credential-centric interface provides the customer visibility into every payment obligation (one time, recurring or otherwise) associated with a payment credential by providing information and management opportunities. The interface may also provide recurring payment information, and “push-button billpay enrollment”.

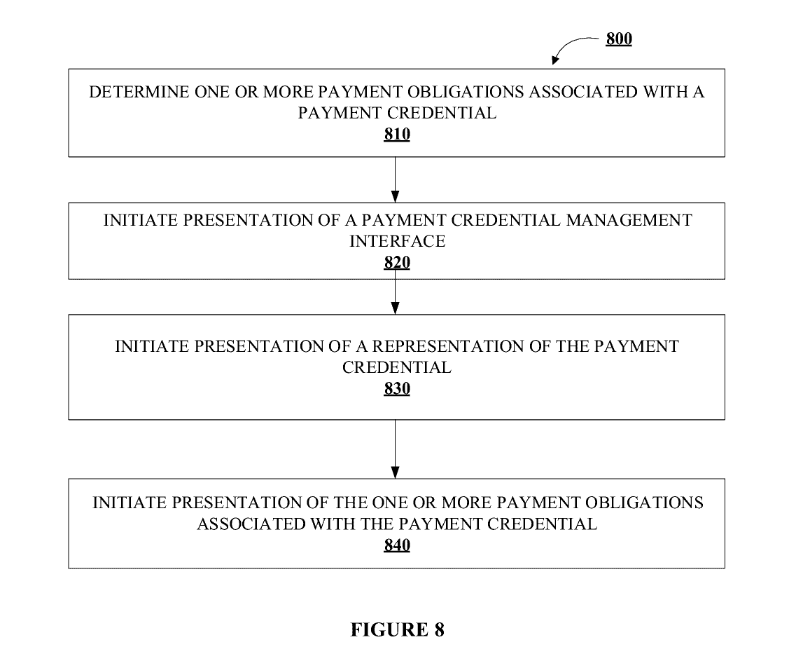

Referring now to FIG. 8, a flowchart illustrates a method 800 for credential management according to embodiments of the invention. The first step, as represented by block 810 is to determine one or more payment obligations associated with a payment credential. The next step, represented by block 820, is to initiate presentation of a payment credential management interface. Next, as represented by block 830, the system initiates presentation of a representation of the payment credential. Finally, as represented by block 840, the system initiates presentation of the one or more payment obligations associated with the payment credential.

In some embodiments, determining the one or more payment obligations associated with the payment credential includes accessing one or more databases to determine whether the payment credential is obligated for a payment having associated information stored in the one or more databases. The payment obligations may be associated with multiple financial institutions and/or payees. Accordingly, the system may require access to multiple, disparate databases to determine whether a particular payment credential has payment obligations. In some instances, the system may determine payment obligations based on determining whether a transaction recurs on a regular basis (e.g., month to month or week to week, etc.).

In some embodiments, determining the one or more payment obligations associated with the payment credential includes determining that the payment credential has been used for one or more recurring transactions for two or more payment periods. In some such embodiments, determining that the payment credential has been used for one or more recurring transactions for two or more payment periods includes determining that the payment credential has been used for two or more consecutive payment periods for a similar transaction comprising a similar transaction amount. In some of these embodiments, determining that the payment credential has been used for one or more recurring transactions for two or more payment periods includes determining that the payment credential has been used for the same transaction amount for two or more consecutive payment periods.

In some embodiments, determining that the payment credential has been used for one or more recurring transactions for two or more payment periods includes determining that the payment credential has been used for a transaction amount within a predetermined percentage threshold of a similar previous payment period. In some embodiments, determining that the payment credential has been used for one or more recurring transactions for two or more payment periods determining that the payment credential has been used for a transaction amount within a predetermined percentage threshold of a corresponding payment period from one year prior.

It will further be understood that a system as contemplated herein can be configured to perform any of the portions of the process flows 600, 700 and/or 800 upon or after one or more triggering events (which, in some embodiments, is one or more any of the portions of the process flows 600, 700 and/or 800). As used herein, “triggering event” refers to an event that automatically triggers the execution, performance, and/or implementation of a triggered action, either immediately, nearly immediately, or sometime after (e.g., within minutes, etc.) the occurrence of the triggering event. For example, in some embodiments, the system performing any of the portions of the process flows 600, 700 and/or 800 is configured such that the system receiving an indication of a compromised payment vehicle or a potential exposure to loss (the triggering event) automatically and immediately or nearly immediately triggers the system to automatically (without human intervention) generate a token for facilitating or completing a pending purchase transaction (the triggered action).

Also it will be understood that, in some embodiments, a predetermined time and/or the passage of a predetermined per any of the portions of the process flows 600, 700 and/or 800. Of course, any of the embodiments described and/or contemplated herein can involve one or more triggering events, triggered actions, automatic actions, and/or human actions.

In addition, it will be understood that, in some embodiments, a system performing any of the portions of the process flows 600, 700 and/or 800 (and/or a user thereof) is configured to perform each portion of the process flows 600, 700 and/or 800 from start to finish, within moments, seconds, and/or minutes (e.g., within approximately 10-15 minutes, etc.). In some embodiments, any of the portions of the process flows 600, 700 and/or 800 are performed in real time, in substantially real time, and/or at one or more predetermined times. Further, it will be understood that the number, order, and/or content of any of the portions of the process flows 600, 700 and/or 800 are exemplary and may vary. It will further be understood that the any of the portions of the process flows 600, 700 and/or 800 can be configured to perform any one or more of the portions of any one or more of the embodiments described and/or contemplated herein.

In various embodiments of the invention, transaction limits and/or thresholds may be used. For example, transaction limits may be used to determine whether a payment credential has been exposed and/or whether to approve or deny a transaction. If a transaction (e.g., transaction information) fails to meet a limit, the transaction may be denied. Alternatively, if a transaction (e.g., transaction information) meets a limit, then the transaction may be allowed.

While the system has been described as determining whether the transaction meets the limits and thereby determining whether an exposure has occurred, in some embodiments filters for determining exposure may also be responsive to transaction information. For example, exceptions to filters may allow a transaction even if a filter is not met. In an embodiment, the system evaluates the transaction information to determine: (1) does the transaction meet the limits; and (2) if the transaction does not meet the limits, does the transaction qualify for an exception to the limits. If the system determines that a positive response to either query, then transaction may be allowed.

In some embodiments, the exceptions are based at least in part upon the transaction information. For example, the system may determine that a transaction does not meet a category limit because doing so would cause the token to exceed the category limit for the time period. In this example, however, the system also determines that the token is near, e.g., within one week, within three days, within one day, or the like, the expiration date of the token or the current evaluation period for the token and that the token has remaining funds in a different category. Given the short period of time remaining for the expenses to be made, the system may determine that the transaction falls within an exception and allow the transaction. In another example, the system may determine that the user is outside of geographic limits defined by a route. The system, however, determines that the user has conducted a transaction at the merchant frequently in the past and therefore allows the transaction based on the previous number of transactions at the merchant. These examples use multiple types of transaction information, e.g., the date of the transaction, the location of the transaction, the category of the transaction, the amount of the transaction, and the like, to determine if the exceptions apply. In some embodiments, only a single piece of transaction information applies. For example, the system may always permit transactions that are associated with a specific category, for example, emergency expenses. The system may always permit transactions at emergency rooms, doctors' offices, and the like.

In some embodiments, the exceptions are determined by the system and/or the user. For example, the system may provide a list of exceptions based on the user's transaction history. If the user has a favorite coffee shop, the system may allow transactions at the coffee shop up to a certain amount even if the transaction would not meet a limit. The user or an administrator may provide exceptions based on location or other transaction information. For example, the user may input exceptions that allow transactions within a specific region, e.g., a city that would not be allowed outside of the specific region. The exceptions may be changed at any time by the system or user. In some embodiments, the system may set geo-fences associated with the exceptions, and automatically transmit or display payment credentials associated with the geo-fence, when the transaction location is within the geo-fence.

The exceptions may be limited by frequency, amount, percentage of the limit, or the like. For example, a transaction may qualify for an exception but only up to a certain percentage of the funds remaining in a related category. For example, a transaction may qualify for an exception because the expense period for the token is almost expired and there are remaining funds in a first category. The system may permit a transaction in a second category up to some percentage (e.g., 50%) of the funds remaining in the first category.

The transaction-responsive limits are designed to provide flexibility to the system and better serve the user. The transaction-responsive limits may be tailored to the user or generic to the token and/or system. By providing for transaction-responsive limits, the system allows transactions that would otherwise be denied based on binary yes/no limits when the transaction information indicates the appropriateness of the transaction.

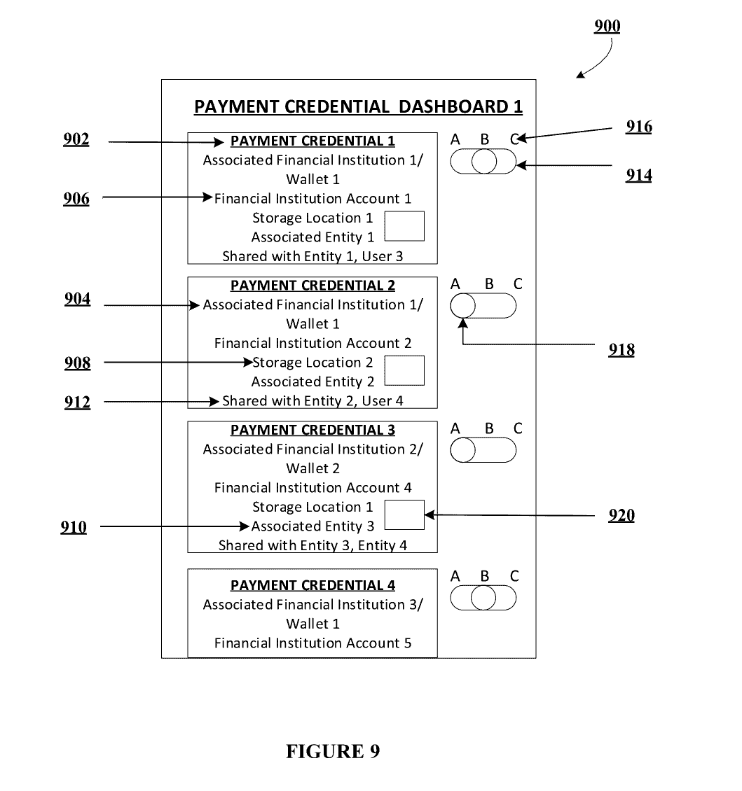

Now referring to FIG. 9, illustrating a payment credential dashboard on the integrated interface according to one embodiment of the invention. The payment credential dashboard is typically displayed on the user device via the integrated interface described previously. The payment credential dashboard is configured to display the payment credentials/tokens along with relevant characteristics of the payment credentials and is configured to enable the user to perform one or more functions associated with the payment credentials. In this regard, in some embodiments, the system may automatically determine one or more payment credentials/tokens and associated characteristics based on retrieving information from one or more user devices, analyzing transaction history of the user, retrieving financial account activity, analyzing social media updates of the user, analyzing a user profile comprising customer information (for example, contact information) and financial information of the user, analyzing transaction history received from merchants/entities and the like. For example, the system may extract payment credential information stored on one or more user devices, remote storage locations and the like based on receiving requisite access permissions and credentials from the user and/or the associated entities. In this regard the system may communicate with and/or establish operative communication channels between one or more user devices, the cloud storage and remote servers associated with entities and other third party systems to access, retrieve and/or modify payment credential information.

As another example, the system may analyze either the user's or an entity's transaction history to determine that the user utilized a first payment credential associated with a first financial institution to execute a transaction with a first entity from an auxiliary user device (for example, a user device different from the device used to display the integrated interface). Continuing with the example, the system may determine that the first payment credential is stored on the auxiliary device and establish an operative communication channel with the auxiliary device to extract relevant information comprising the token identifiers, one-time pass code generation key and the like. The system may further analyze the transaction history and determine that the user shared the first payment credential with an indirect user (for example, a relative of the user) or that the indirect user utilized the first payment credential for a transaction with another entity. In some embodiments the user may provide at least a portion of the information associated with the payment credentials via a user device and/or the integrated interface. In some embodiments, the system determines the token identifiers associated with the payment credential and utilizes the token identifiers to perform one or more functions. In other embodiments, the system may be owned by a financial institution and the financial institution may correlate the token identifiers to one or more financial institution accounts by querying a token account database. In some embodiments, the system may extract information associated with the payment credentials from one or more locations for display on the integrated interface, in real time, based on receiving a request from the user or automatically in response to trigger events.

The system may then determine one or more wallets associated with the each of the one or more payment credentials. In some embodiments, the system may determine the one or more wallets associated with each payment credential based on the type of token identifier, information from user devices, transaction history, user profiles, third party databases and the like. In some embodiments, the user may associate one or more of the determined payment credentials with appropriate digital wallets and the system may verify the association before displaying the association on the integrated interface and performing transactions. In some embodiments, information associated with the wallets, for example authorization credentials, wallet identifiers and the like may be requested from the user at least for a first time, typically prior to execution of transactions. In some embodiments, the system determines usage limits, parameters and rules associated with the one or more payment credentials and the one or more associated wallets. In some embodiments, the system presents an integrated interface on a user device by extracting information associated with the wallets and their payment credentials from their individual locations and presenting the payment credentials on a single interface.

In some embodiments, the system may display the one or more payment credentials 902 on the integrated interface along with one or more characteristics of the payment credential as shown in payment credential dashboard 900 of FIG. 9. For example, the each payment credential 902 may comprise a panel with the characteristics of the payment credential and relevant information displayed within the panel. The payment credential 902 may be input by the user or established by an entity, comprising the token identifiers, alphanumeric strings identifying the token, titles/labels, pictorial attributes, images, icons or any other suitable means for the user to uniquely identify/recognize the payment identifier. In some embodiments the payment credential 902 may be accompanied by one or more payment credential characteristics comprising associated financial institution and/or the wallet 904, financial institution account directed to the payment credential 906, storage location 908, entities associated with the payment credential 910, information about other indirect users and entities that the token is shared with 912 and the like. The payment credential 902 may be accompanied by other characteristics like validity of the payment credential, amounts associated with the payment credential (spent amount, available amount, spending limits and the like), most recent transaction information, loyalty account information (entity associated with the loyalty program, available points and the like), one or more offers associated with the payment credential, wallet or the financial institution account and other relevant information. In some embodiments, the system enables the user to choose the content and appearance the payment credentials 902 and associated characteristics, while in other embodiments the system determines the optimal display.

In some embodiments, the dashboard comprises associated financial institution and/or wallet information 904 for the one or more payment credentials. For example, the system may determine that a second payment credential is directed to an account or a payment instrument associated with the first financial institution. The system may further determine that the second payment credential is associated with a first wallet owned/operated by the first financial institution or another entity. In this regard the system may display the name, title, user defined label, pictures, icons or other identifiers directed to the financial institution and the wallet associated with the payment credential. In some embodiments the dashboard comprises financial institution accounts 906 associated with the wallet. In this regard, the financial institution account 906 may comprise the type of account (for example: savings account, checking account and the like) or financial instrument (for example: credit card, debit card and the like) that the payment credential is directed to. In some embodiments, the financial institution account 906 may comprise alphanumeric titles, labels, images, either provided by the user or determined by the system to enable the identification the financial institution account. Typically, to maintain the security of the financial account information, the financial account information 906 is displayed without the actual account numbers, routing numbers, credit card numbers and other identifiers. However, these account identifiers may be displayed to the user in some embodiments, with or without additional authentication of the user. In some embodiments the dashboard displays one or more locations 908 where the payment credential is stored. The system may determine the one or more locations 908 comprising cloud storage, remote server, memory device associated with one or more user devices, secure elements or integrated circuit chips associated with one or more user devices and the like. In this regard system may also display the entity that owns and/or operates the storage location and the type or name of user device in the instances where the payment credential is stored on one or more user devices. In some embodiments the storage location 908 is the location from which the system extracted the information associated with the payment credential. In some embodiments the storage location 908 may indicate that the payment credential is directed to an online wallet associated with an online merchant.

In some embodiments the interface may comprise one or more entities 910 associated with the payment credential 902. In some embodiments, the entity 910 may one or more entities that the user designated/assigned the token to be used in transactions with. For example, the user may designate a particular payment credential for automatic recurring payments directed to a merchant or another financial account. In some embodiments, the entity 910 may be the entity that owns the wallet (for example, a third party entity) and/or the entity that created/governs the operation of the token (for example, an issuing financial institution). In some embodiments the entity 910 may indicate whether the payment credential is assigned to be used for in-store transactions in physical stores or online transactions. In some embodiments, the interface may comprise information about other indirect users and entities that the token is shared with 912. In this regard the shared entity 912 may indicate entities and/or indirect user that possess the payment credential information, token identifiers and the like. For example, the system may determine that the user provided the payment credential information to an entity either while creating a profile and/or while executing a transaction. In this regard the system may determine the shared entity 912 based on analyzing the transaction history of the payment credential. As another example, the system may determine that the user “pushed” (shared) a payment credential to a wallet associated with an indirect user for use in transactions along with predetermined usage limits. In another aspect, shared entity 912 may reflect the payment credentials received from one or more entities or indirect users (for example, payment credentials owned by other entities or indirect users shared with or pushed to one or more of the user's wallets).

In some embodiments, the payment credential 902 may be accompanied by one or more images 920 to enable the user to easily recognize of identify the payment credential 902. In some embodiments images 920 comprise audiovisual elements extracted from various sources associated with the financial institution and/or wallet of the payment credential 902, associated entity 910, shared users 912 or other characteristics, either singularly or in combination to enable the user to easily identify and operate the payment credential from the integrated interface without accessing separate interfaces. In some embodiments the payment credential 902 may comprise a panel augmented with one or more payment credential characteristics and images 920. In some embodiments the panel may comprise the payment credential 902 and the characteristics (904-920) overlaid on the panel separate from each other, overlapping each other or in any other suitable manner. In some embodiments, the panel is actionable in that, the characteristics (904-920) may be displayed initially in a first manner (for example, partial display of information, concise display, in small size or relatively obscure view, display with hyperlinks) and may be displayed in a second manner (for example, with complete content, with additional relevant information, with a larger size, more legible view, with audiovisual elements, with change in color, size, appearance and/or orientation and the like) based on swipe patterns, user selection of a characteristic, voice commands, gestures and other actions of the user. In some embodiments, the display in the second manner may comprise generation of new dashboards or views, display of new windows or panels, redirecting the user to other parts of the integrated interface or other interfaces and the like.

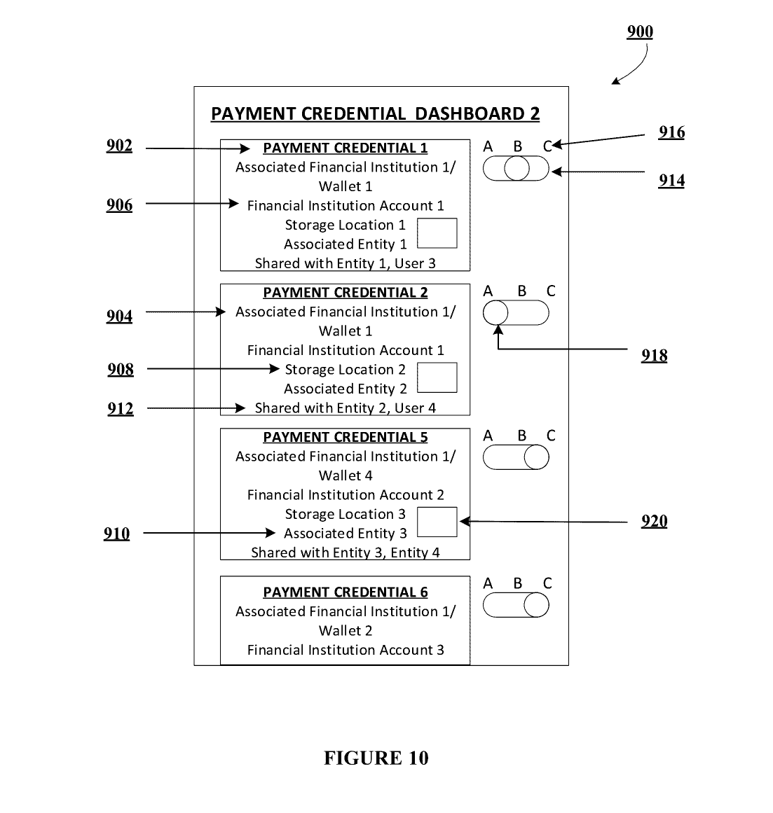

In some embodiments, the system is configured to provide one or more dashboards based on the user input. In this regard the system is configured to sort, categorize, group, select and array the payment credentials for display on the integrated interface, in real time, in response to a request from a user. In some embodiments, the system may display all available payment credentials based on a suitable order, for example: usage frequency, recent use in transactions, and the like. In some embodiments, the integrated interface may comprise a dashboard menu screen capable of receiving user input directed to display of payment credentials. In some embodiments, the user may indicate a criteria or one or more conditions for display or sorting of the payment credentials on the integrated interface. The criteria or conditions may be based on one or more characteristics of the payment credential, ordering or sorting rules and the like. In response the system may create a new dashboard for display on the integrated interface, based on the received criteria and display the payment credentials accordingly. For example, the user may request display of all tokens associated with a particular financial institution. The system may generate a new payment credential dashboard 2, displaying the payment credentials associated with the financial institution as illustrated by FIG. 10. In this regard, the elements on the payment credential dashboard 2 may be substantially similar to those illustrated in FIG. 9. As illustrated by FIG. 10, the system displays the payment credentials associated with a first financial institution by extracting the payment credentials from multiple wallets and storage locations. Similar dashboards may be created for display of credentials of other criteria, either alone or in combination. For example, the system may display the payment credentials associated with a particular entity or the payment credentials shared with/received from an indirect user.

In some embodiments, the system may determine the optimal payment credentials automatically and display and/or initiate transactions with the appropriate payment credentials. In this regard the system may analyze the type of transaction (for example: online or in-store), merchant, type of products or services associated with the transaction, previous transaction history associated with the merchant and/or the type of products or services and determine optimal payment credentials for use. In some embodiments, the system may seek confirmation from the user before automatically initiating/executing transactions with the optimal payment credentials. In some embodiments, the system may display a list of optimal payment credentials on a dashboard, on the integrated interface and execute a transaction based on receiving a selection of at least one payment credential from the user. In some embodiments, receiving a selection of at least one payment credential may be determined to be a confirmation for initiation/execution of the transaction.

The system, in some embodiments, may be configured to perform one or more functions associated with the payment credentials. In some embodiments the one or more functions may be directed to initiating and executing transactions by utilizing one or more payment credentials. The transactions may be payment transactions, deposit transactions, money transfer and the like. In some embodiments, the functions may be directed to assigning or modifying one or more parameters governing the use, storage, transfer and the like of the payment credentials. In some embodiments the panels comprising the payment credentials 902 may comprise links or other functionality which enables creation of new windows, panels, pop-up boxes and the like to enable the user to perform the functions associated with the payment credentials. In some embodiments, the dashboard of the integrated interface may comprise graphical manipulation tools and control elements like checklists, tables, drop down lists, list boxes, pop-up menus, widgets, radio buttons, toggle switches, toolbars, text boxes and the like to enable user selection of parameters, navigation through the interface, user input of one or more parameters, and display of confirmation or output. In some embodiments, the interface enables the user to modify parameters associated with individual payment credentials or modify parameters associated with a group of payment credentials in a dashboard altogether.

For example, a toggle switch or a slider 914 is illustrated in FIGS. 9 and 10, although other graphical control elements may be used in various embodiments. The toggle switch 914 may comprise an indicator 918 that is displaced corresponding to the variation of a value of a parameter, the levels of variation being indicated by the limit bar 916. Although three levels of variation are illustrated in the limit bar 916, more or fewer levels of variation or alternatives/preferences may be provided to the user. Each payment credential 902 may be associated accompanied by one or more toggle switches 914. The toggle switches may enable the user to modify the parameters associated with the token. In some embodiments, the toggle switches indicate the current status of the parameter and also indicate the modification of the parameter either in response to receiving an input from the user, or in response to automatic modifications by the systems. For example, the toggle switches 914 may be configured to activate and/or deactivate the financial instrument in response to receiving user input and thereby indicating the availability of the payment credential for use in transactions. As another example the toggle switches may be used to indicate if the payment credential is directed to online transactions, in-store transactions or both. In response to an input from the user the system may transform one type of payment credential into another by modifying the token identifiers and the like. In some embodiments, the system enables the user to modify one or more parameters, characteristics, limits and the like associated with the payment credentials, delete payment credentials and add payment credentials through the integrated interface. In this regard the system establishes communication channels with the storage locations, entity databases and external systems and transmits control signals, in real time, to cause the respective systems to update the relevant data. For example, if the user modifies a particular payment credential, resident on an auxiliary device via the integrated interface of a primary user device, the system automatically updates the information on the auxiliary device so that the changes are reflected, in real time, when the user initiates a purchase with the auxiliary device. Continuing with the example, the system may also update the payment credential information in entity databases and user devices (of both the user and indirect users) of entities and users that are either associated with the payment credential or that the payment credential has been shared with. In some embodiments the updating of payment credential information is automatic while in other embodiments it is done in response to a request from a user.

Typically, the integrated interface is configured to enable the user to perform one or more functions associated with the payment credentials. In some embodiments, the system enables the user to add, modify or remove one or more payment credentials. In some embodiments, the integrated interface enables the user to designate one or more payment credentials for transactions related to one or more merchants, type of transactions, products, location of the transaction, transaction amount and other parameters. In this regard, the system may automatically invoke the appropriate payment credential at the point of transaction based on the predetermined user-preferences. In some embodiments, the integrated interface enables the user to transfer payment credentials between user devices seamlessly. In this regard the system may extract payment credential information from one device and transfer the information to a second device in some embodiments, or establish communication links between devices in other embodiments, so that the user can access the payment credential stored on other devices through the integrated interface. In some embodiments the integrated interface may enable the user to transfer, share or push one or more payment credentials to one or more wallets associated with indirect users. Indirect users may individuals who have a relationship with the user, for example family, employer/employee and the like. In this regard, the system may utilize payee lists associated with the user and/or the user's financial accounts to extract the required information to transfer the payment credentials. In some embodiments, the system may receive information associated with the indirect users. The system may transmit the payment credentials to the indirect user's wallet by wireless communication, near field communication, the internet, by email, text messages or any other suitable means. In some embodiments, the integrated interface enables the user to assign one or more limits associated with transactions that can be performed by the indirect user using the transferred payment credential. For example, the limits can be monetary limits, geographic limits, time period limits, validity limits, limits directed to type of permitted products, number of permitted transactions within a time period and the like. In some embodiments the system may notify the user and/or seek validation when the indirect user initiates a transaction with the transferred payment credential. The system may notify the user via the interface, through text messages, emails, phone calls, vibratory and/or audible alerts or any other suitable notification means.

In some embodiments, the system determines one or more offers associated with transactions performed using the payment credentials. The system may display the one or more offers associated with one or more payment credentials and/or the wallets on the payment credential dashboard. In some embodiments, the system automatically applies the suitable offers to transactions performed using the integrated interface, while in other embodiments the system receives a selection of a suitable offer from the user. In some embodiments, the integrated interface enables the user to monitor and redeem loyalty points accrued from one or more transactions executed using the integrated interface. In some embodiments, the interface enables the user to monitor and/or modify pending transactions associated with payment credentials. In some embodiments, the system enables the user to retrieve transaction history associated with one or more payment credentials.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. As used herein, “at least one” shall mean “one or more” and these phrases are intended to be interchangeable. Accordingly, the terms “a” and/or “an” shall mean “at least one” or “one or more,” even though the phrase “one or more” or “at least one” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

To supplement the present disclosure, this application further incorporates entirely by reference the following commonly assigned patent applications:

| Docket Number | U.S. patent application Ser. No. | Title | Filed On |
|---|---|---|---|
| 6070US1.014033.2138 | 14/196,816 | MANAGED DIGITAL | Mar. 4, 2014 |
| | | WALLETS | |
| 6071US1.014033.2153 | 14/196,798 | TOKEN COLLABORATION | Mar. 4, 2014 |
| | | NETWORK | |
| 6071US2.014033.2154 | 14/196,802 | FORMATION AND FUNDING | Mar. 4, 2014 |
| | | OF A SHARED TOKEN | |
| 6072US1.014033.2151 | 14/196,364 | LIMITING TOKEN | Mar. 4, 2014 |
| | | COLLABORATION | |
| | | NETWORK USAGE BY USER | |
| 6072US2.014033.2152 | 14/196,373 | LIMITING TOKEN | Mar. 4, 2014 |
| | | COLLABORATION | |
| | | NETWORK USAGE BY | |
| | | TOKEN | |
| 6073US1.014033.2149 | 14/196,809 | LIMITING THE USE OF A | Mar. 4, 2014 |
| | | TOKEN BASED ON A USER | |
| | | LOCATION | |
| 6073US2.014033.2150 | 14/196,813 | AUTHORIZING A | Mar. 4, 2014 |
| | | TEMPORARY TOKEN FOR A | |
| | | USER | |
| 6074US1.014033.2148 | 14/196,030 | CONTROLLING TOKEN | Mar. 4, 2014 |
| | | ISSUANCE BASED ON | |
| | | EXPOSURE | |
| 6075US1.014033.2146 | 14/196,292 | FLEXIBLE FUNDING | Mar. 4, 2014 |
| | | ACCOUNT TOKEN | |
| | | ASSOCIATIONS | |
| 6075US2.014033.2147 | 14/196,350 | ACCOUNT TOKEN | Mar. 4, 2014 |
| | | ASSOCIATIONS BASED ON | |
| | | SPENDING THRESHOLDS | |
| 6076US1.014033.2144 | 14/196,383 | ONLINE BANKING DIGITAL | Mar. 4, 2014 |
| | | WALLET MANAGEMENT | |
| 6076US2.014033.2145 | 14/196,653 | CUSTOMER TOKEN | Mar. 4, 2014 |
| | | PREFERENCES INTERFACE | |
| 6076US3.014033.2172 | 14/196,752 | CREDENTIAL PAYMENT | Mar. 4, 2014 |
| | | OBLIGATION VISIBILITY | |
| 6077US1.014033.2143 | 14/196,919 | PROVIDING | Mar. 4, 2014 |
| | | SUPPLEMENTAL ACCOUNT | |
| | | INFORMATION IN DIGITAL | |
| | | WALLETS | |
| 6078US1.014033.2142 | 14/196,894 | PROVIDING OFFERS | Mar. 4, 2014 |
| | | ASSOCIATED WITH | |
| | | PAYMENT CREDENTIALS IN | |
| | | DIGITAL WALLETS | |
| 6078US2.014033.2179 | 14/196,869 | PROVIDING OFFERS | Mar. 4, 2014 |
| | | ASSOCIATED WITH | |
| | | PAYMENT CREDENTIALS | |
| | | AUTHENTICATED IN A | |
| | | SPECIFIC DIGITAL WALLET | |
| 6079US1.014033.2141 | 14/196,257 | FOREIGN EXCHANGE | Mar. 4, 2014 |
| | | TOKEN | |
| 6079US2.014033.2173 | 14/196,274 | FOREIGN CROSS-ISSUED | Mar. 4, 2014 |
| | | TOKEN | |
| 6080US1.014033.2140 | 14/196,545 | DIGITAL WALLET | Mar. 4, 2014 |
| | | EXPOSURE REDUCTION | |
| 6080US2.014033.2174 | 14/196,460 | MOBILE DEVICE | Mar. 4, 2014 |
| | | CREDENTIAL EXPOSURE | |
| | | REDUCTION | |
| 6081US1.014033.2139 | 14/196,947 | ATM TOKEN CASH | Mar. 4, 2014 |
| | | WITHDRAWAL | |
| 6151US1.014033.2194 | 14/196,034 | RESTORING OR REISSUING | Mar. 4, 2014 |
| | | OF A TOKEN BASED ON | |
| | | USER AUTHENTICATION | |
| 6152US1.014033.2195 | 14/196,405 | TOKEN USAGE SCALING | Mar. 4, 2014 |
| | | BASED ON DETERMINED | |
| | | LEVEL OF EXPOSURE | |
| 6858US1.014033.2532 | To be assigned | MERCHANT TOKENIZATION | Concurrently |
| | | MIGRATION | herewith |
| | | INFRASTRUCTURE SYSTEM | |
| 6859US1.014033.2533 | To be assigned | TOKENIZATION | Concurrently |
| | | PROVISIONING AND | herewith |
| | | ALLOCATING SYSTEM | |
| 6860US1.014033.2534 | To be assigned | NON-INTRUSIVE GEO- | Concurrently |
| | | LOCATION | herewith |
| | | DETERMINATION | |
| | | ASSOCIATED WITH | |
| | | TRANSACTION | |
| | | AUTHORIZATION | |
| 6860US2.014033.2535 | To be assigned | NON-INTRUSIVE GEO- | Concurrently |
| | | LOCATION | herewith |
| | | DETERMINATION | |
| | | ASSOCIATED WITH | |
| | | TRANSACTION | |
| | | AUTHORIZATION | |
| 6861US1.014033.2537 | To be assigned | TOKEN PROVISIONING FOR | Concurrently |
| | | NON-ACCOUNT HOLDER | herewith |
| | | USER WITH LIMITED | |
| | | TRANSACTION FUNCTIONS | |
| 6862US1.014033.2538 | To be assigned | ACCOUNT TOKENIZATON | Concurrently |
| | | FOR VIRTUAL CURRENCY | herewith |
| | | RESOURCES | |

What is claimed is:

1. An apparatus for electronic collection, display and association of one or more payment credentials by providing an integrated digital wallet management interface, whereby the apparatus provides a comprehensive management platform for managing multiple digital wallets and their associated payment credentials and allowing control of the credentials, the apparatus comprising:
at least one memory;
at least one processor; and
a module stored in the memory, executable by the at least one processor, and configured to cause the at least one processor to:
initiate presentation of the integrated digital wallet management interface for display on a mobile device associated with a user;
receive a user input via the integrated digital wallet management interface, wherein the user input comprises one or more conditions to retrieve information associated with the one or more payment credentials;
establish a communication link with a storage location associated with each of the one or more payment credentials;
retrieve the information associated with the one or more payment credentials from each of the storage locations via the communication link, wherein the information comprises one or more digital wallets associated with the one or more payment credentials; and
initiate presentation of one or more representations of the one or more payment credentials on the integrated digital wallet management interface and at least one indication of which of the one or more digital wallets are associated with each of the one or more payment credentials.

2. The apparatus of claim 1, wherein the storage location associated with the one or more payment credentials comprises a cloud storage, an external memory device, an internal memory device associated with the mobile device, and a subscriber identification module (SIM) card associated with the mobile device.

3. The apparatus of claim 1, wherein the module is further configured to cause the at least one processor to:
receive a user selection of at least one digital wallet and/or at least one payment credential from the one or more representations of the one or more payment credentials; and
receive user input setting a usage limit for the at least one digital wallet and/or the at least one payment credential via the integrated digital wallet management interface.

4. The apparatus of claim 3, wherein the usage limit is a threshold spending limit for an aggregation of all the payment credentials associated with the at least one digital wallet.

5. The apparatus of claim 3, wherein the usage limit is a threshold spending limit to be applied to each of the payment credentials associated with the at least one digital wallet individually.

6. The apparatus of claim 3, wherein the usage limit is a threshold number of transactions for an aggregation of all the payment credentials associated with the at least one digital wallet.

7. The apparatus of claim 3, wherein the usage limit is a threshold number of transactions applied to each of the payment credentials associated with the at least one digital wallet individually.

8. The apparatus of claim 3, wherein the usage limit is a timing limit to be applied to an aggregation of all the payment credentials associated with the at least one digital wallet.

9. The apparatus of claim 3, wherein the usage limit is a timing limit to be applied to each of the payment credentials associated with the at least one digital wallet.

10. The apparatus of claim 1, wherein the integrated digital wallet management interface is accessed by a user authenticated through an online banking session administered by a financial institution also administering the digital wallet.

11. The apparatus of claim 1, wherein the module is further configured to cause the at least one processor to:
receive a user selection of at least one digital wallet associated with an indirect user; and
transmit at least one transfer payment credential to the at least one digital wallet associated with the indirect user via the integrated digital wallet management interface.

12. The apparatus of claim 11, wherein the transfer payment credential comprises one or more transaction limits, wherein the one or more transaction limits comprise monetary limits, geographic limits and time period limits.

13. A method for electronic collection, display and association of one or more payment credentials by providing an integrated digital wallet management interface, whereby at least one processor provides a comprehensive management platform for managing multiple digital wallets and their associated payment credential and allowing control of the credentials, the method comprising:
initiating, by the at least one processor, presentation of the integrated digital wallet management interface for display on a mobile device associated with a user;
receiving, by the at least one processor, a user input via the integrated digital wallet management interface, wherein the user input comprises one or more conditions to retrieve information associated with the one or more payment credentials;
establishing, by the at least one processor, a communication link with a storage location associated with each of the one or more payment credentials;
retrieving, by the at least one processor, the information associated with the one or more payment credentials from each of the storage locations via the communication link, wherein the information comprises one or more digital wallets associated with the one or more payment credentials; and
initiating, by the at least one processor, presentation of one or more representations of the one or more payment credentials on the integrated digital wallet management interface and at least one indication of which of the one or more digital wallets are associated with each of the one or more payment credentials.

14. The method of claim 13, wherein the storage location associated with the one or more payment credentials comprises a cloud storage, an external memory device, an internal memory device associated with the mobile device, and a subscriber identification module (SIM) card associated with the mobile device.

15. The method of claim 13, wherein the method further comprises:
receiving, by the at least one processor, a user selection of at least one digital wallet and/or at least one payment credential from the one or more representations of the one or more payment credentials; and
receiving, by the at least one processor, user input setting a usage limit for the at least one digital wallet and/or the at least one payment credential via the integrated digital wallet management interface.

16. The method of claim 13, wherein the usage limit is a threshold spending limit for an aggregation of all the payment credentials associated with the at least one digital wallet.

17. The method of claim 13, wherein the usage limit is a threshold spending limit to be applied to each of the payment credentials associated with the at least one digital wallet individually.

18. A computer program product for electronic collection, display and association of one or more payment credentials by providing an integrated digital wallet management interface, whereby the computer program product provides a comprehensive management platform for managing multiple digital wallets and their associated payment credentials and allowing control of the credentials, the computer program product comprising a non-transitory computer-readable medium comprising code causing a first apparatus to:
initiate presentation of the integrated digital wallet management interface for display on a mobile device associated with a user;
receive a user input via the integrated digital wallet management interface, wherein the user input comprises one or more conditions to retrieve information associated with the one or more payment credentials;
establish a communication link with a storage location associated with each of the one or more payment credentials;
retrieve the information associated with the one or more payment credentials from each of the storage locations via the communication link, wherein the information comprises one or more digital wallets associated with the one or more payment credentials; and
initiate presentation of one or more representations of the one or more payment credentials on the integrated digital wallet management interface and at least one indication of which of the one or more digital wallets are associated with each of the one or more payment credentials.

19. The computer program product of claim 18, wherein the storage location associated with the one or more payment credentials comprises a cloud storage, an external memory device, an internal memory device associated with the mobile device, and a subscriber identification module (SIM) card associated with the mobile device.

20. The computer program product of claim 18 further causing a first apparatus to:
receive a user selection of at least one digital wallet and/or at least one payment credential from the one or more representations of the one or more payment credentials; and
receive user input setting a usage limit for the at least one digital wallet and/or the at least one payment credential via the integrated digital wallet management interface.
